(19) United States
(12) Patent Application Publication
(10) Pub. No.: US 2026/0056874 A1
(43) Pub. Date: Feb. 26, 2026

(54) SYSTEM AND METHOD FOR LIVE MONITORING OF EMBEDDED INFERENCE MODULES

(71) Applicant: RENESAS ELECTRONICS AMERICA, INC., SAN JOSE, CA (US)

(72) Inventors: JEFFREY M. SIERACKI, CLARKSVILLE, MD (US); BHAVANA MADAM SAMPANGIRAMU, OTTAWA (CA)

(21) Appl. No.: 19/303,222

(22) Filed: Aug. 18, 2025

Related U.S. Application Data
(60) Provisional application No. 63/685,390, filed on Aug. 21, 2024.

(51) Int. Cl. G06F 11/3668; G06F 11/30; G06F 11/32; G06N 20/00

(52) U.S. Cl. CPC G06F 11/3692; G06F 11/3013; G06F 11/324; G06N 20/00

(57) ABSTRACT

A system and method are provided for monitoring inferences performed by a microcontroller (MC) in real time. An inference module embedded on the MC analyzes a data set and generates a determination value, then transmits a determination data payload representing the determination value and, in some embodiments, the data set to a monitoring subsystem. The inference module may be an AI module, which may be trained on data sets previously transmitted from the MC. The monitoring subsystem may visually represent the determination value on a user interface, generate a verification value to test the determination value for accuracy, and store the determination data payload to a memory for later refinement of the inference module.

### CROSS-REFERENCE TO RELATED APPLICATIONS

This application is based on, and claims the benefit of priority of, U.S. Provisional Patent Application No. 63/685,390, filed on 21 Aug. 2024, at the U.S. Patent and Trademark Office, which is incorporated by reference herein in its entirety.

### BACKGROUND OF THE INVENTION

### 1. Field

The disclosure relates to the development of embedded modules within a product. More particularly, the disclosure relates to the development, monitoring, testing, and debugging of embedded AI/ML inference modules, or other analysis modules, in situ on a product.

### 2. Description of Related Art

It has become common to use microcontrollers (MCs) in a wide range of modern electronic devices, from small appliances to automobiles. These MCs provide compact, low-power, cost-effective computing, with firmware (permanently programmed software) providing the core functionality of the product. MCs typically include only the components necessary for their specific function, with limited connectivity and capability, making them different from general-purpose computers and much less convenient to program.

An MC's functionality may require it to make determinations based on input from various sources as part of controlling the device. As a few non-limiting examples: A device may need to self-diagnose based on internal sensor input and determine whether circumstances warrant shutting down an ongoing function to prevent a hazardous situation, such as overheating or a power surge. A device in motion may need to identify obstacles using input from cameras, LIDAR, and similar sensors, and determine whether to alter course. A device may include biometric sensors that need to distinguish a valid user from an invalid one, and activate functions only for the former. To make these determinations, analysis modules may be included in the MC firmware. These modules are configured to receive input and interpret it as part of the decision-making process.

For simple, predictable scenarios with only a few input variables, an engineer might code a decision structure for an analysis module using, for example, if-then-else loops, while-do loops, and other basic programming techniques. However, the analysis of more complex scenarios may require an inference module. Such modules are usually, though not exclusively, generated through an artificial intelligence or machine learning (AI/ML) training process, using a training set of data examples with known correct outcomes. The training process enables the module to make a determination based on new data collected during operation, such as classifying input (classifier) or assigning a value (regression). Examples of AI/ML decision structures include, but are not limited to, Neural Networks (NN), Deep Learning, Support Vector Machines (SVM), Random Forest, Decision Trees, Logistic Regression, and K-Nearest Neighbor.

As is well understood in the art, inference modules are less deterministic than hand-crafted algorithms and are more susceptible to unpredictable errors. Therefore, thorough testing of the accuracy of these modules is essential to maintaining product quality.

### SUMMARY OF THE INVENTION

It is an aspect of the disclosed system and method to enable the monitoring, testing, and debugging of software in situ on computer systems that are not easily accessed or modified due to their limited capabilities and connectivity, such as embedded microcontrollers in an end-product.

It is another aspect of the disclosed system and method to present output and other data from the monitored software in an intuitive manner.

It is yet another aspect of the disclosed system and method to collect training data for an AI/ML inference module, intended for embedding in an end product, that accurately reflects the state of data as it will be received by the module in the end product.

These and other aspects may be attained in a system and method for live monitoring of embedded inference modules.

In accordance with certain embodiments of the present invention, a system is provided for monitoring inferences performed by a microcontroller (MC) in real time. The system includes an MC communicatively coupled to an electronic device, and a monitoring subsystem external to the MC and communicatively coupled to the MC. The MC includes at least one MC processor, an MC communication stack configured to transmit and receive a signal, and an MC memory having embedded thereon MC program code executable by the at least one MC processor. The MC program code includes an inference module configured to cause at least one of the at least one MC processor to analyze a data set and generate a determination value corresponding thereto. The electronic device selectively performs at least one operation based on the determination value. The MC program code further includes a payload module configured to cause at least one of the at least one MC processor to generate, for each determination value generated by the inference module, a determination data payload representing the determination value, and to transmit the determination data payload through the MC communication stack. The monitoring subsystem includes at least one monitoring processor, a monitoring communication stack configured to transmit and receive a signal, a display, and a monitoring memory having encoded thereon monitoring program code executable by the at least one monitoring processor. The monitoring program code includes a monitoring module configured to cause at least one of the at least one monitoring processor to process a plurality of determination data payloads received through the monitoring communication stack and originating from the MC communication stack. The monitoring program code further includes an interface module configured to cause at least one of the at least one monitoring processor to visually render a user interface on the display. The user interface visually represents the determination value of at least one determination data payload of the plurality of determination data payloads.

In accordance with other embodiments of the present invention, a method is provided for monitoring inferences performed by an MC in real time. The method includes establishing an MC. The MC includes at least one MC processor, an MC communication stack configured to transmit and receive a signal, and an MC memory having embedded thereon an inference module. The method further includes establishing a monitoring subsystem external to the MC and communicatively coupled to the MC. The monitoring subsystem includes at least one monitoring processor, a monitoring communication stack configured to transmit and receive a signal, a monitoring memory, and a display. The method further includes, by the at least one MC processor, obtaining a plurality of data sets. The method further includes, by the at least one MC processor, for each data set of the plurality of data sets, analyzing the data set to generate at least one determination value corresponding thereto, generating a determination data payload representing the determination value, and transmitting, through the MC communication stack, the determination data payload. The method further includes, by the at least one monitoring processor, receiving, through the monitoring communication stack, a plurality of determination data payloads originating from the MC communication stack. The method further includes, by the at least one monitoring processor, generating a user interface on the display representing the determination value of each processed determination data payload of the received plurality of determination data payloads.

In accordance with still other embodiments of the present invention, a method is provided for training and refining an artificial intelligence (AI) module of an MC. The method includes establishing an MC. The MC includes at least one MC processor, an MC communication stack configured to transmit and receive a signal, and an MC memory. The method further includes establishing a trained AI module. The method further includes embedding the trained AI module to the MC memory. The method further includes establishing a testing subsystem external to the MC and communicatively coupled to the MC. The testing subsystem includes at least one testing processor, a testing communication stack configured to transmit and receive a signal, a testing memory, and a display. The method further includes, by the at least one MC processor, obtaining a plurality of testing data sets. The method further includes, by the at least one MC processor, for each testing data set of the plurality of testing data sets, analyzing the testing data set to generate at least one testing determination value corresponding thereto, generating a testing data payload representing the testing determination value, and transmitting, through the MC communication stack, the generated testing data payload. The method further includes, by the at least one testing processor, receiving, through the testing communication stack, a plurality of testing data payloads originating from the MC communication stack. The method further includes, by the at least one testing processor, generating a user interface on the display representing the at least one testing determination value of each processed testing data payload of the received plurality of testing data payloads.

Additional aspects will be set forth in part in the description that follows and, in part, will be apparent from the description, or may be realized by practice of the presented embodiments of the disclosure.

### BRIEF DESCRIPTION OF THE DRAWINGS

The above and other aspects and features of certain embodiments of the present disclosure will become more apparent from the following description, taken in conjunction with the accompanying drawings, in which:

FIG. 1 illustrates a hardware environment in which various embodiments of the subject system and method may be implemented;

FIG. 2 illustrates an example hardware configuration of a microcontroller that various embodiments of the subject system and method may monitor;

FIGS. 3A and 3B are block diagrams illustrating abstracted relationships between functional code modules in a system for monitoring an embedded analysis module, according to certain embodiments of the disclosure;

FIG. 4 is a flow diagram illustrating an example flow of processes for configuring an embedded analysis module to be monitored, according to an embodiment of the disclosure;

FIGS. 5A-5C are flow diagrams illustrating example flows of processes for inference determinations in a classifier-type analysis module, according to certain embodiments of the disclosure;

FIG. 6A is a flow diagram illustrating an example flow of processes for an embedded application to provide analysis data, according to an embodiment of the disclosure;

FIG. 6B is a flow diagram illustrating an example flow of processes for an embedded application to reconfigure operations, according to an embodiment of the disclosure;

FIG. 7 is a sequence diagram illustrating an example operation flow for controlling the operations of an embedded payload module from a host system, according to an embodiment of the disclosure;

FIG. 8 illustrates an example implementation of a graphic user interface for a data collection application module, according to an embodiment of the disclosure;

FIGS. 9A-9L illustrate example implementations of a graphic user interface for a monitoring application module, according to certain embodiments of the disclosure;

FIG. 10 is a flow diagram illustrating an example flow of processes for receiving and presenting analysis data in a monitoring application module, according to an embodiment of the disclosure; and

FIG. 11 is a flow diagram illustrating an example flow of processes for preparing and configuring an embedded analysis module in the related art; and

FIG. 12 is a block diagram illustrating an example computer system for programmatic and/or hardware implementation of various embodiments and aspects of the present invention.

### DETAILED DESCRIPTION OF THE PREFERRED EMBODIMENTS

This disclosure will now refer in detail to exemplary embodiments illustrated in the accompanying drawings, with like reference numerals denoting like elements throughout. The embodiments are described below to elucidate the disclosed system and method, with reference to the figures shown in the drawings for selected exemplary embodiments and their sample applications.

Though this disclosure provides illustrations and descriptions, it is not intended to be exhaustive or to limit the implementations to the precise forms disclosed herein. Modifications and variations are possible in view of this disclosure and, additionally, may be obtained through the practice of the implementations. Furthermore, one or more features or components of one embodiment may be incorporated into or combined with another embodiment (or with one or more features of another embodiment). Additionally, in the flowcharts and the descriptions of operations provided below, it is understood that one or more operations may be omitted or added, or the operations may be performed simultaneously (at least in part) or rearranged in their order.

The flowchart and block diagrams in the drawings illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the drawings. In some alternative implementations, the functions noted in the blocks may occur out of the order noted in the drawings. For example, two blocks shown in succession may, in fact, be executed concurrently or substantially concurrently, or may sometimes be executed in the reverse order, depending upon the functionality involved.

It will be apparent that the systems and methods described herein may be implemented in various forms of hardware, firmware, or combinations of hardware and software. For example, each block illustrated in the provided diagrams and flowcharts, by itself or in combination with others, may be implemented by special purpose hardware-based systems that perform the specified functions, or that carry out combinations of special purpose hardware and computer instructions. Specific specialized control hardware or software code used to implement these systems and methods is not a limit on the scope of implementations. Therefore, the operation and behavior of the systems and/or methods described herein are presented without referencing specific software code, as it is understood that software and hardware can be designed to implement the systems and/or methods based on this description.

Even though particular combinations of features are recited in the claims and/or disclosed in the specification, these combinations are not intended to limit the scope of possible implementations. To the contrary, many of these features can be combined in ways not explicitly recited in the claims and/or disclosed in the specification. Although each dependent claim listed below may directly depend on only one claim, the disclosure of possible implementations includes each dependent claim in combination with every other claim in the claim set.

No element, act, or instruction used herein should be interpreted as critical or essential unless explicitly defined as such. Additionally, the articles “a” and “an” should be interpreted to encompass one or more items and may be used interchangeably with “one or more.” When only one item is intended, the term “one” or similar language will be employed. Furthermore, the terms “has,” “have,” “having,” “include,” “including,” or similar terms should be interpreted as open-ended. Moreover, the phrase “based on” should be interpreted to mean “based, at least in part, on” unless stated otherwise. Furthermore, expressions like “at least one of [A] and [B]” or “at least one of [A] or [B]” should be interpreted as including implementations having only A, only B, both A and B, and/or any of their variations.

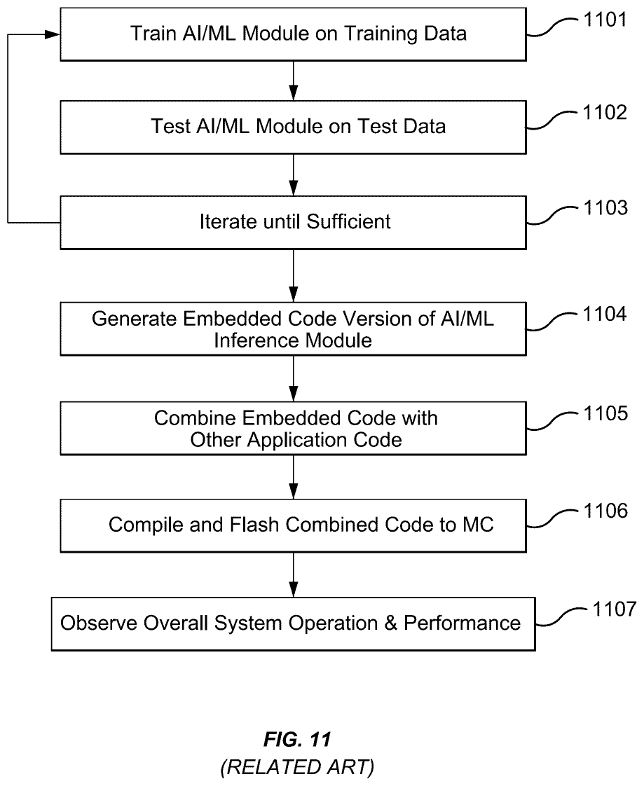

FIG. 11 is a flow diagram illustrating a typical process flow for developing artificial intelligence/machine learning (AI/ML) inference modules and deploying them to a microcontroller (MC). Briefly, the operations of the process are:
1101. Train an AI/ML inference module on training data.
1102. Test the AI/ML inference module on test data.
1103. Check whether the module accuracy is sufficient; if not, repeat 1101 and 1102.
1104. Generate an embedded code version of the AI/ML inference module.
1105. Combine the embedded code version with other application code.
1106. Compile and flash the combined code to an MC.
1107. Observe the module's overall system operation and test its performance in situ on the MC.

Operations 1101, 1102, and 1103 are typically performed using training and testing tools operating either on a host system, such as a desktop workstation, or on servers, depending on the scale of the data. Operations 1104 and 1105 are typically performed on the host system or, in some embodiments, in cloud-based software. Thus, the bulk of development and testing occurs outside the MC.

On the host system, the behavior of the AI/ML module can be examined in detail, including both performance accuracy and internal operational aspects. However, at operation 1107, after the module is embedded on the MC, only the overall system operation is usually visible. This makes it difficult to understand and troubleshoot issues with the AI/ML module that occur within the context of the intended system.

There are several reasons why the operations and behavior of the AI/ML module might differ on the MC compared to the original host system:

(1) The data itself is different. A collection of pre-recorded data, such as that used during the initial training and testing, is inherently limited in natural, real-world variation. Once the system is deployed, the settings and context of operation may lead to differences in the data that are not well represented in the pre-recorded training and testing data. Additionally, in some instances, changes in the transfer and processing of data samples (the data channel) may be inadvertently introduced between the original training data collection process and the later, live operation of the AI/ML module.

(2) Embedded systems often require lower computational resolution, making quantization of higher-resolution data necessary. An AI/ML module operating on a computer workstation can typically utilize high-precision math (e.g., 64-bit floating-point). In contrast, an MC typically operates at reduced resolution (e.g., 32-bit floating-point, 16-bit fixed-point, or even 8-bit integers). The lower resolution enables faster processing within the MC's native capabilities but, as a trade-off, introduces rounding and truncation errors that reduce the accuracy of the AI/ML module.

(3) Other modules operating on the MC within the complete system can introduce differences. When other functions compete for resources in the MC, the behavior of any system component can change due to, for example, interrupt handling, RAM usage, and other complications associated with resource sharing.

(4) The physical system in which the MC operates can influence the data that reaches the module. Noise, systematic voltage issues, sensor vibration, and similar factors create distortions in data signals, which have a more significant impact on MC components than on larger systems, and which may not be easily simulated outside the MC's system.

Testing processes typically rely on programmatic debugging tools within an Integrated Development Environment (IDE). These tools enable an engineer to set breakpoints and inspect internal data values while the MC is operating. However, these tools are very general-purpose, metaphorically enabling the user to look closely at the trees but not at the overall forest. Because AI/ML requires understanding numerous interconnected pieces simultaneously to grasp operational issues, such traditional debugging tools are often cumbersome and time-consuming when used for debugging AI/ML modules.

Other measures include testing embedded code operations in a simulation or on the host system, or by flashing a custom application to the MC. Results from such testing on the MC typically include measurements of accuracy and operational speed. These measures offer a basic assessment of an AI/ML module's functionality on an MC, but they have significant limitations for several reasons.

First and foremost, these testing measures typically use a dedicated “toy” application running on the MC, designed solely to exercise the AI/ML module and communicate with the host. Such an application does not include the complete user MC software or the full context of the product system, so it cannot address points (3) and (4), and can only partially address point (1). These applications mainly focus on point (2) by testing the basic functionality of the embedded system as affected by quantization.

These measures also offer limited visibility into real-time operation. Many embedded systems simply act on the output of the AI/ML. Designers are usually not motivated to configure the system to share this information with an external observer in production. Extra code in an embedded project costs space, processing time, and manhours to develop, so direct monitoring of the AI/ML itself is typically not considered. Even systems that provide monitoring generally do so through an abstracted notification—for example, a warning light changing color or a message indicating a fault in a particular system component. In rare cases, an engineer may hand-build a monitor that provides the current state of the AI/ML output, such as the classifier's current “class,” possibly along with limited score information. However, even this does not offer a history to show the context and stability of the decisions, and it particularly lacks a record of internal states or source data, which could significantly aid in issue identification and debugging. In some situations, AI/ML modules can make numerous inferences per second, making it highly limiting to observe only the instant output.

Briefly, example embodiments of the present disclosure provide a method and system in which an analysis module, such as an AI/ML inference module, can be thoroughly tested and debugged while embedded in the intended product.

Embodiments of the disclosed method and system offer significant improvements over the ad hoc arrangements described above. They address all of points (1), (2), (3), and (4) by enabling the user to test live within the embedded product's context. Additionally, they enable the collection of training and testing data that more closely matches the data the module will encounter during actual use. They also provide a detailed history of states and internal data, which can be used to understand and enhance the operation of both the AI/ML module and the entire product. Moreover, they offer a highly convenient way to quickly demonstrate and evaluate the operation of such a module in situ without requiring additional effort by the engineering team.

As noted above, and as will be further established, certain principles disclosed herein have particular advantages in the context of the training and testing of artificial intelligence and machine learning inference modules. For illustrative purposes, this disclosure will focus on embodiments in that specific context. However, it will be appreciated by those skilled in the art that the same principles can be extended to apply to the monitoring and debugging of other firmware and embedded systems, and will continue to provide at least some of the same advantages in these other contexts, especially but not exclusively other forms of analysis modules and inference modules. As such, the subject system and method may also be suitably implemented in other categories of systems and are not limited to those explicitly disclosed.

Additionally, for simplicity, this disclosure will use the descriptors “artificial intelligence” and “machine learning” interchangeably to refer to the field of training software algorithms using existing training data with predetermined correct outcomes, and to the resulting inference modules that are trained by this process to provide correct outcomes in response to new data.

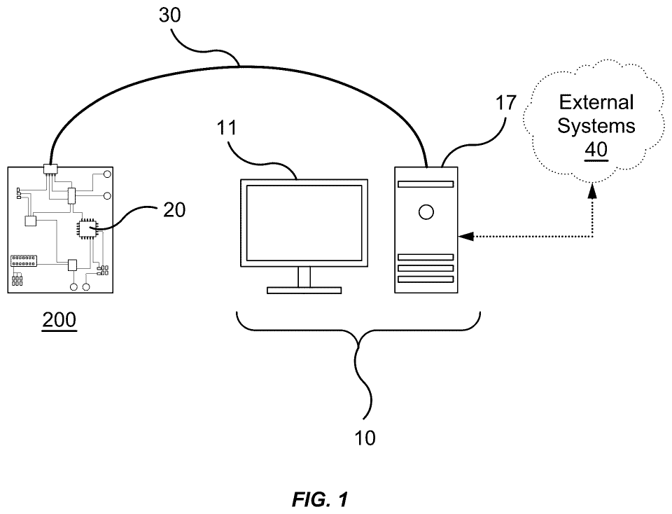

FIG. 1 illustrates an example hardware environment in which the subject system and method may be implemented.

A circuit board 200 housing a microcontroller (MC) 20 may be installed within or otherwise coupled to any electronic device, and may direct the device to selectively perform operations by the transmission of control signals to appropriate components. As but one illustrative example, if the circuit board 200 is coupled to a motor control system of the device, it may direct various motor components to increase or decrease activity in response to user input, readouts from internal motor control states, outputs of additional sensors such as electrical meters, encoders, accelerometers, and thermometers, and/or other factors.

The circuit board 200 is communicatively coupled to a host system 10 via a connector 30. The connector 30 may be a dedicated debugger connection, UART, USB, Ethernet, SPI, i2C, or other communication cable, or a combination thereof. In some embodiments, a wireless connection such as Wifi or Bluetooth may be employed.

Various applications and software modules may operate on the host system 10. These may include, for example, an IDE (Integrated Development Environment) 17 that combines editing, debugging, and compiler tool chains. Through the IDE, an engineer may create source code, compile the code to binary, flash the binary onto the target MC 20 for embedded execution, and operate standard debugger functions for monitoring code execution. The host system 10 may also be connected to other systems 40 via a network, to access remote application services including, for example, development tools used to create and optimize modules.

Embodiments of the disclosed system and method additionally provide a monitoring application module 11 (more simply, “the monitor”) on the host system 10. The monitor 11 may be incorporated as a plug-in for the IDE 17, or it may reside in a separate application. By operating the monitor 11, the host system acts as a monitoring subsystem for the MC 20.

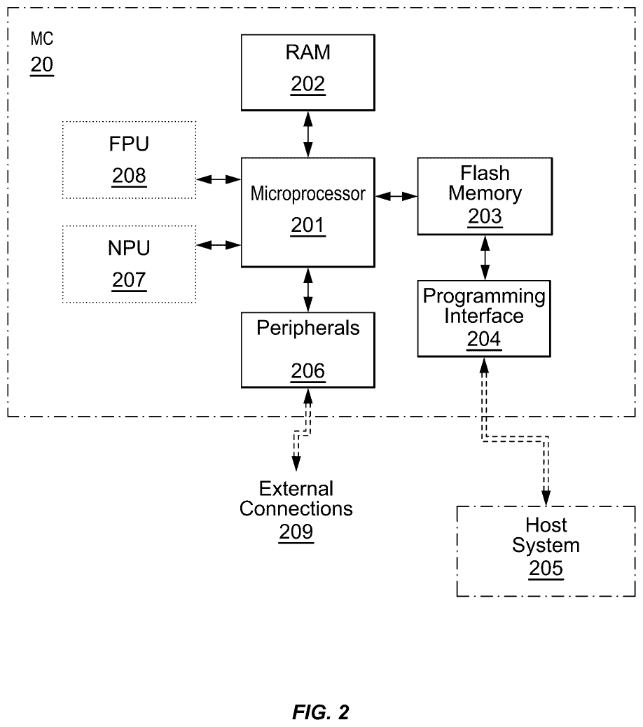

FIG. 2 illustrates an example hardware configuration of a microcontroller, such as MC 20. The components are typically implemented in hardware on a silicon die and connected electrically to power and external peripherals.

The core element of the MC is a microprocessor 201, typically operating at a lower clock rate and with lower capability than the general-purpose processors found in computer workstations and servers.

The microprocessor 201 is coupled to a random access memory (RAM) 202, typically used for dynamic storage of information. Portions of RAM 202 may be directed to different forms of storage, such as general storage, tightly coupled memory (TCM), cache, and so forth.

The microprocessor 201 is also coupled to a flash memory 203, typically used for program code and permanent data storage. The flash memory 203 stores information that, once it has been written, remains available even after the processor is powered off or rebooted. For this reason, program code stored on the flash memory 203 is sometimes referred to as “firmware” rather than “software.”

Data and code are typically written to the flash memory 203 via an external programming interface subsystem 204, which receives data from an external host to program the device. Communication between the external programming interface subsystem 204 and the external host may be through any suitable connection known in the art, such as UART, USB, or a dedicated connection, such as a J-Link device. While FIG. 2 assumes the external host to be the host system 10 of FIG. 1, it may also be a dedicated device of another type. For example, a system used in the mass manufacture of the MC may “burn” firmware into the device on a production line. Additionally, different external hosts may be used at different times.

An MC 20 will typically also have onboard peripherals 206 through which it may communicate. These may include one or more external connectors 209 such as UART, USB, Ethernet, SPI, i2C, or other communication cables, or a combination thereof. The peripherals 206 may also include sensor channels such as analog-to-digital converters. The MC 20 will typically use such connectors and channels to operate functions and electrically control other physical elements of the circuit board 200 or the overall product system within which the MC 20 resides.

An MC 20 may also include processing components that operate in conjunction with the microprocessor 201 to speed up certain operations. These processing components may include a floating point unit (FPU) 208, which will accelerate floating point operations. More advanced MCs may include a neural processing unit (NPU) 207, designed to accelerate certain AI/ML-specific operations. Other possible components, not depicted, might include a digital signal processing unit (DSP). These processing units are optional, and the simplest MCs may use only the microprocessor 201, optimized for fast, low-power, integer math operations. In such cases, any floating point, AI/ML, or DSP-type operations may instead be implemented through software.

An alternative to the implementation of FIG. 1 may incorporate the basic functionality of the MC 20, as elaborated on with reference to FIG. 2, along with additional external peripheral devices and interfaces, on a single physical chip component. This implementation is commonly referred to as a system-on-a-chip (SoC). An SoC implementation simplifies the physical design over a standard circuit board 200 as depicted in FIG. 1, but otherwise operates in the same general manner.

The disclosed system may operate in any context where an MC or similar device is employed, including on a development or evaluation board, in an SoC, or on a manufacturer's own custom board. It can also be used when the embedded operations are simulated on a host computer. This flexibility is absent from many other systems that function only in the context of specific evaluation boards and cannot be used with “production” hardware.

With an exemplary environment established for context, the disclosure will now describe how data analysis is performed in that environment.

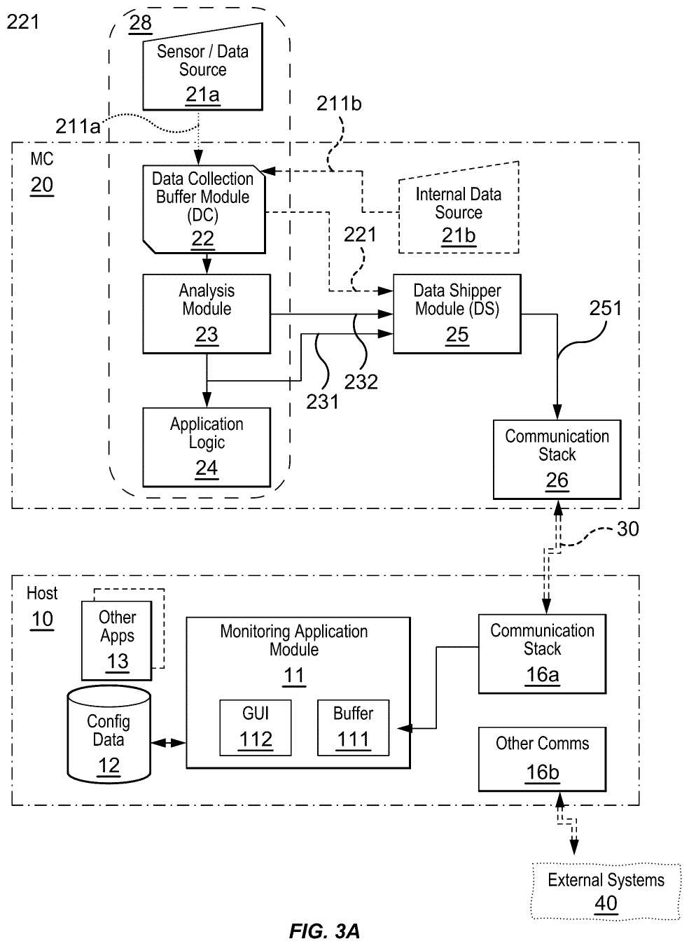

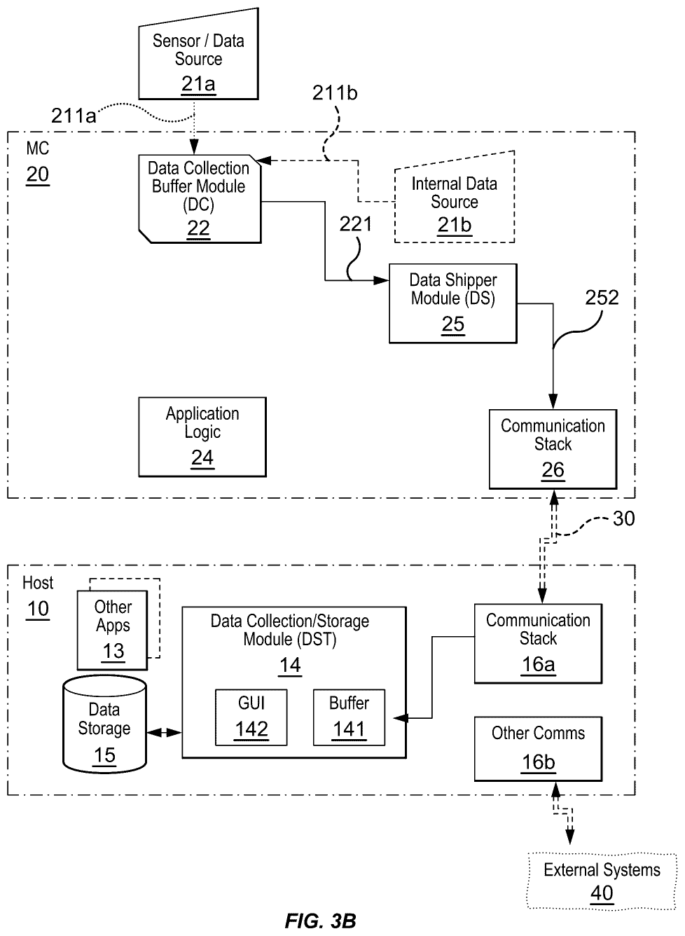

FIG. 3A is a block diagram illustrating an abstracted relationship between functional code modules on the MC 20 and the host system 10 in the context of data analysis, according to an embodiment of the disclosure. FIG. 3A assumes that a core application 28 has been prepared and flashed to the MC 20. In the illustrated system, the core application 28 includes application logic 24, which is supported by an analysis module 23. The analysis module 23 may be an artificial intelligence/machine learning (AI/ML) module or other inference module that generates inferences based on received data, but it is not limited thereto.

An external data source 21a, such as one or more sensors, is coupled via a peripheral connection to a data collection buffer module (DC) 22 embedded on the MC 20. The external data source 21a provides external data 211a to the DC 22 for temporary storage in a buffer. The peripheral connection may, in certain cases, enable additional buffering, such as may be necessary to capture small frames of data from the source. For example, the device as a whole may use “direct memory access” (DMA) to write small arrays of information to a buffer, which is serviced by an interrupt to feed these to the remainder of the system. In other cases, the external data 211a may be provided value by value.

In the illustrated system, an internal data source 21b is also provided, and provides internal data 211b to the DC 22. The internal data 211b may include variables or values that are generated by other processes in the MC 20, in contrast to the external data 211a, which comes directly from an external source 21a. For example, if the MC 20 is part of a motor control circuit, an algorithm may generate internal parameter values representing the motor's state, and a sequence of internal values from the algorithm may form the basis of data vectors 211b provided to the DC 22.

Various embodiments may use any number of external data sources 21a and/or internal data sources 21b, as suitable to the needs of the system as a whole.

The data 211a and/or 211b may be received as frames or individual values. The DC 22 may be configured to organize the data 211a and/or 211b into longer frames or arrays, which may also be termed “data segments” or “data sets,” by aggregation and/or segmentation. Each data segment is formatted, sized, and otherwise configured in accordance with the configuration of an analysis module 23, for analysis thereby. Each data segment has a window length and may have one or more channels of data, forming an array of input data for the analysis module 23. The data in the data segment may comprise one or more channels of any combination of signals, including but not limited to visual, audio, vibration, electrical, RF, and internal variables, each broken into time-based segments for evaluation and analysis. The source data 211a and 211b may therefore be thought of as signals that are segmented in time, although the data may be initially received in another form.

The data segments need not be independent. In some embodiments, it is advantageous to overlap one data segment with the previous. As but one example, in certain audio analysis algorithms, each data segment retains 50% of the previous data segment while filling in the other 50% with new data. This approach enables the analysis module 23 to generate more determinations per unit of time without waiting for new signal data, and may also exhibit the advantage of better handling of transitions between output states. This configuration can also be used in conjunction with “smoothing” (discussed later) to decrease momentary errors in output.

In some embodiments, the analysis module 23 may receive the data 211a and/or 211b more directly and may segment it as part of its own processes. However, for convenience, this disclosure will assume that segmentation is performed in the DC 22.

As the DC 22 segments the data, it provides the resulting data segments 221 to the analysis module 23 sequentially. The analysis module 23 may be configured to analyze each data segment and generate a determination value based thereon. The determination value may also be termed a prediction or prediction value, and may represent a class, a detection event, a numerical value, or other possible outputs known in the art, depending on the nature of the analysis process. For each data segment, a unique and new analysis result may be generated.

For convenience, only one analysis module 23 is illustrated, but a plurality of analysis modules, each generating its own determination values, is within the scope of the disclosure. As such, the illustrated system may be extended by duplication for each such additional instance within the system.

The output of the analysis module 23 is provided to the application logic 24 of the core application 28 and acted upon. The application logic 24 encapsulates the larger operation of the embedded system, as designed to direct operations of the device as a whole.

The details of the application logic 24 vary wildly according to the needs of the device. As but one example, a vibrating mechanical system, such as a washing machine, will be briefly discussed. In this example device, the analysis module 23 may be configured to detect a certain type of anomalous behavior. The data source 21a may be an accelerometer, and the analysis module 23 may output one of two classes as a determination value: “normal” or “anomalous.” Based on an “anomalous” output, the application logic 34 may perform one or more operations: it may adjust system operations to reduce vibrations, shut down operations entirely, or activate an alarm, among other possibilities.

In this and other contexts, the analysis module 23 is a component used to decide or detect conditions on which the remainder of the system, such as the application logic 24, can act. While the operations of the application logic 24 are the “end goal” of the analysis module 23 and of the device itself, this disclosure is focused on monitoring of the analysis module 23, and as such, it will not discuss the application logic 24 further.

The core application 28 is illustrated in FIG. 3A in a manner intended to emphasize the operations of the analysis module 23. It will be understood that the illustrated functional blocks need not be simple, sequential program code, but may be implemented through the application of multiple processes running on the MC 20 in an interrupt-mediated process or under a real-time operating system (RTOS), among other possibilities known in the art.

To support monitoring of the core application 28, and more specifically the analysis module 23, a data shipper module (DS) 25 is provided. The DS 25, which may also be termed a payload module, aggregates information from the monitored core application 28. The DS 25 captures the output 231 of the analysis module 23 (e.g., the determination values), as well as, preferably, internal analysis data 232 (e.g., one or more intermediary values generated during interim steps in the analysis and used to arrive at the final determination 231). As each determination 231 is outputted by the analysis module 23, the DS 25 packages the corresponding information into a determination data payload or data packet 251, which is sent via a communications stack 26 to the host system 10.

Optionally, the raw data segments 221 from the DC 22 may also be collected by the DS 25 and included in the payload 251. This additional data enables a comparison of determinations made on the MC 10 (namely, determinations 231) with determinations made on a higher resolution system, such as the host system 10, as will be described shortly. It also enables the recording and reuse of data as part of further offline testing or training; an example of this will be described further herein with reference to FIG. 3B. Both are very powerful tools for monitoring. However, the data segments 221 are typically significantly larger than the internal analysis data 232 and output 231. As such, packaging the data segments 221 and transmitting the resultingly larger payload 251 may substantially impact the performance of the MC 20. Preferably, therefore, the inclusion of the raw data segments 221 in the payload 251 is configurable and can be enabled or disabled according to an analyst's needs.

The communication stack 26 may comprise buffers, firmware, and other processes used by the MC 20 to send data over a known communication channel 30. The communication channel 30 may be any suitable connection known in the art, including but not limited to UART, USB, J-Link, SPI, I2S, Bluetooth, or other communication type supported by the MC 20.

Data through the communication channel 30 (e.g., payload 251) is received by a corresponding communications stack 16a operating within the host system 10, which may comprise buffers, firmware, and other processes. For convenience and brevity, the communication stack 26 on the MC, the communication channel 30, and the corresponding communications stack 16a on the host 10 may be collectively termed a “communication bus” herein.

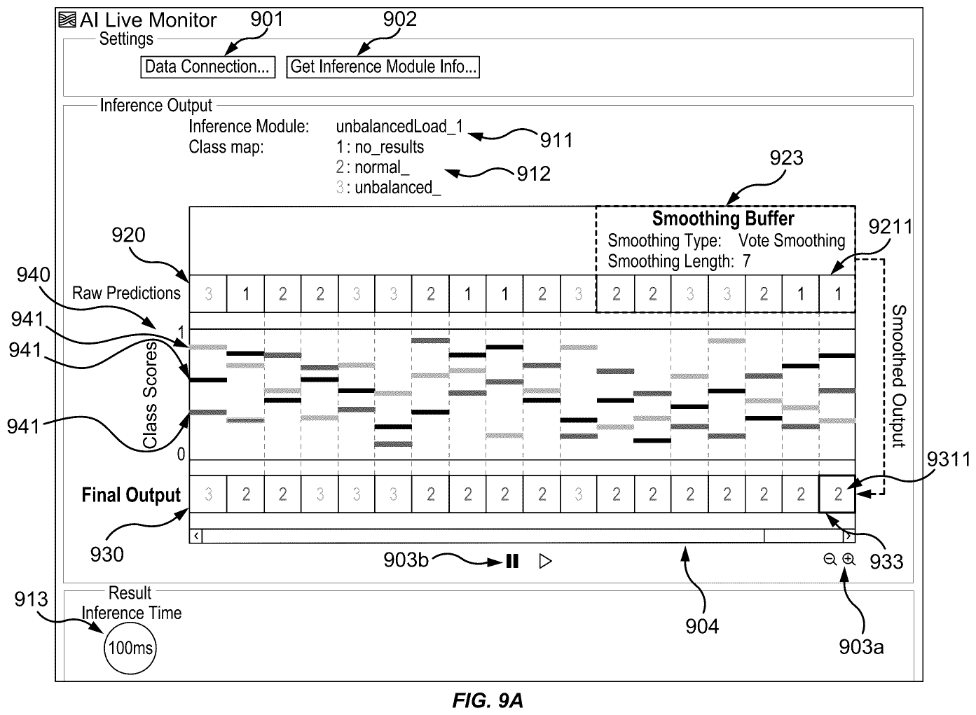

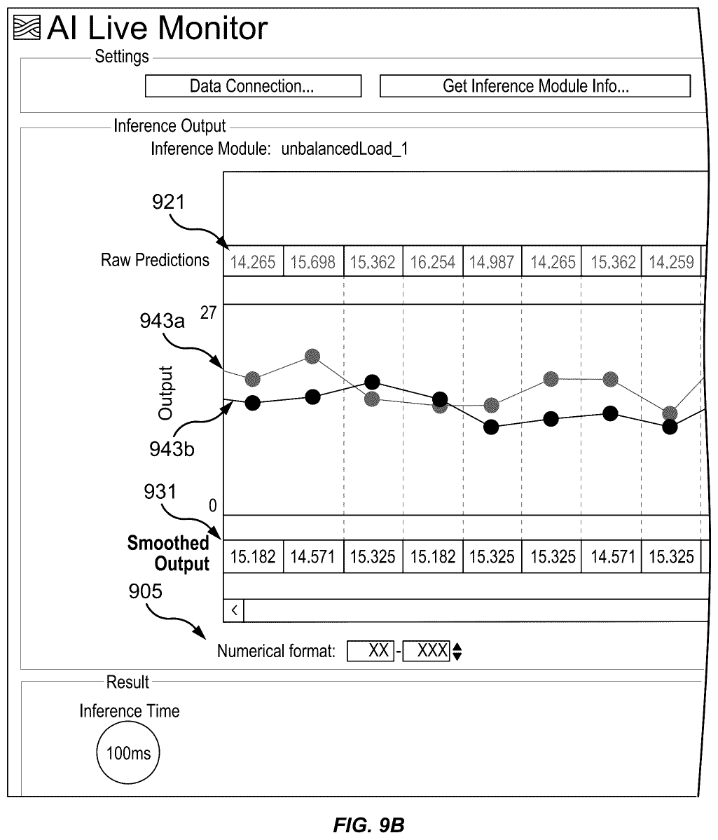

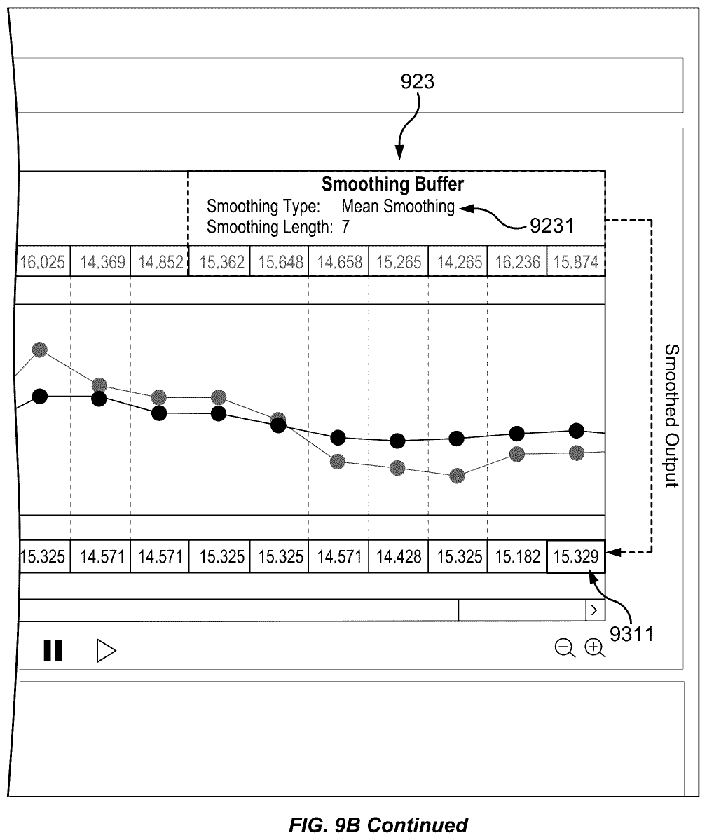

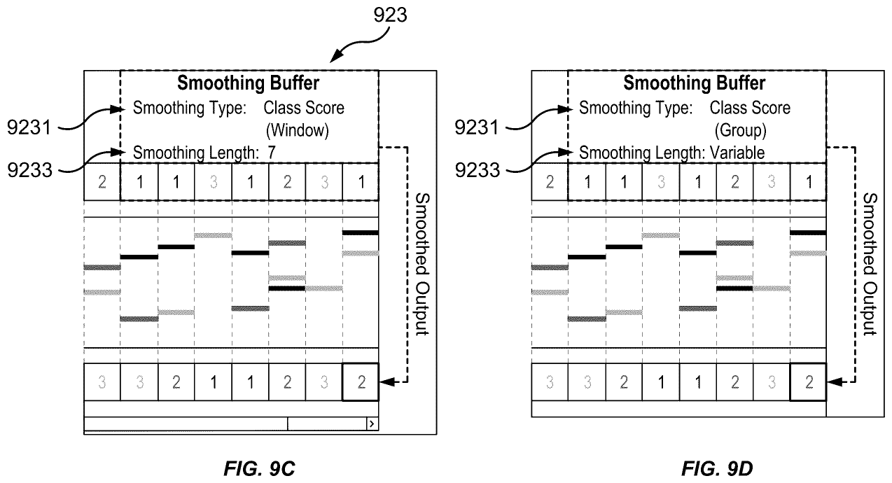

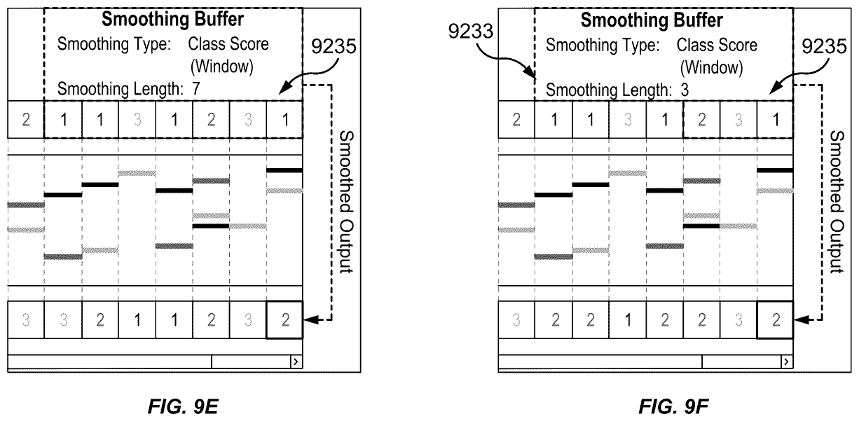

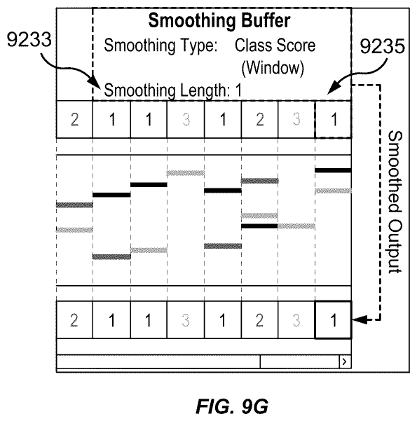

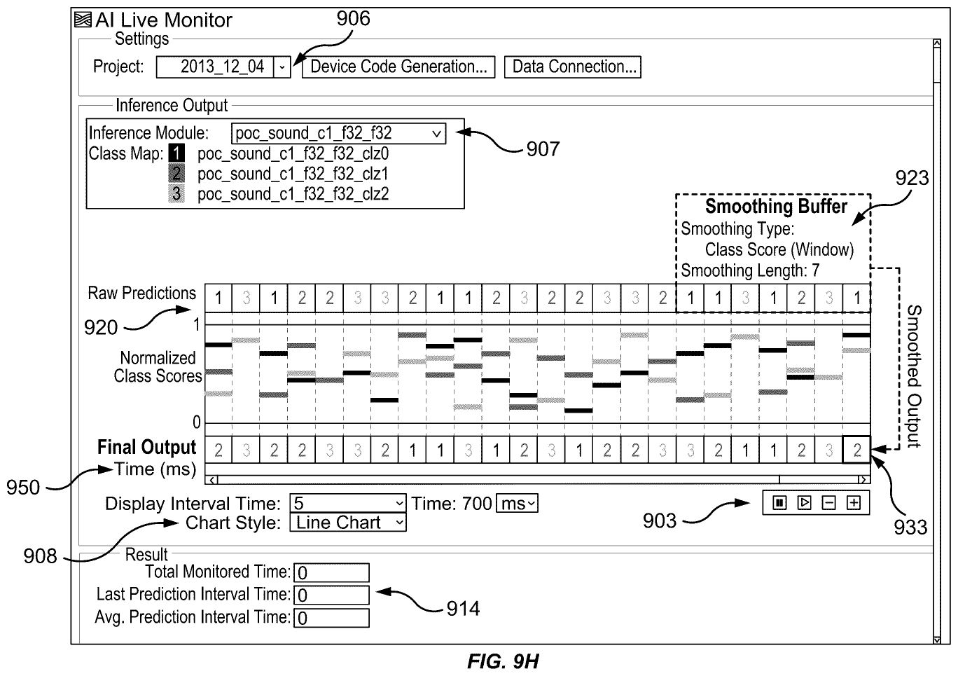

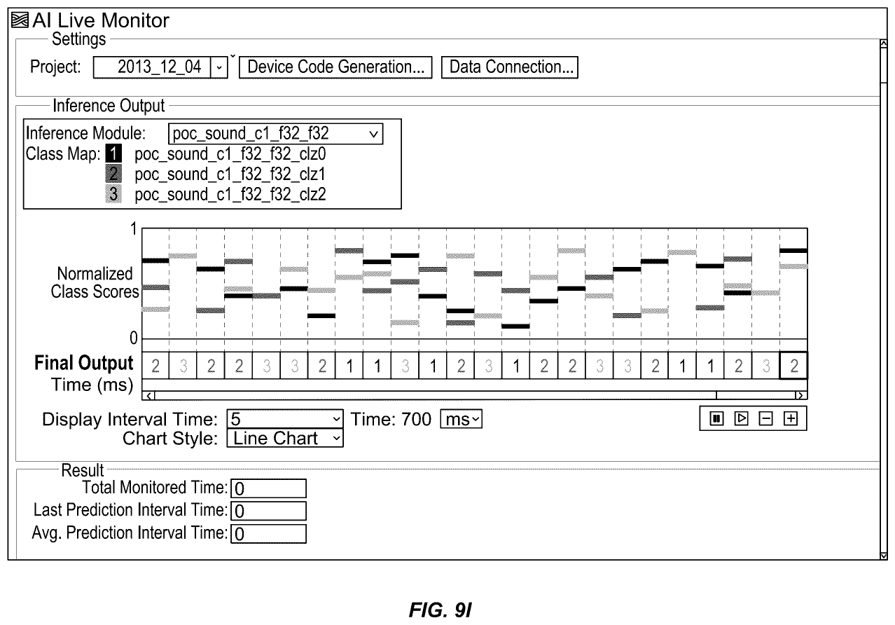

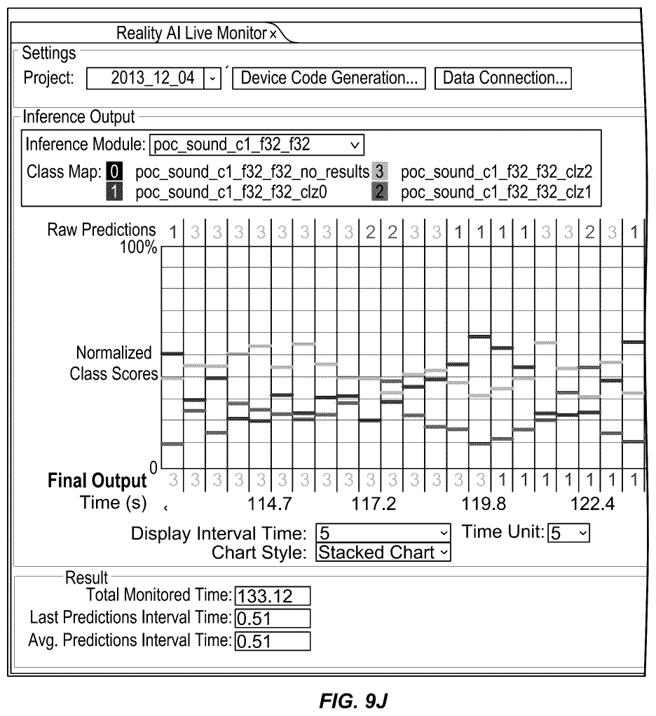

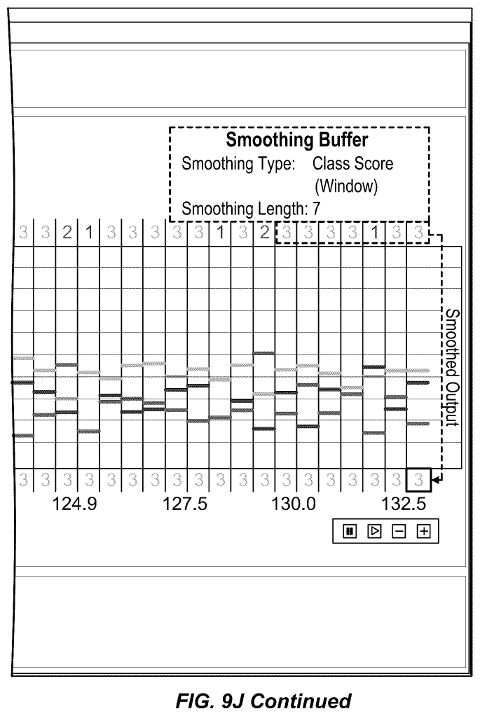

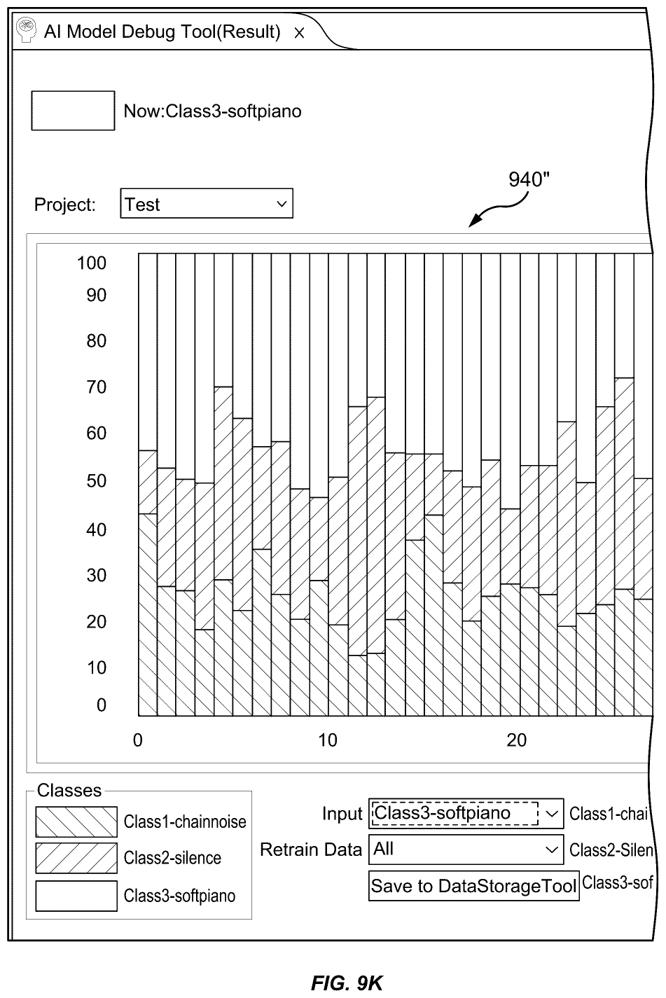

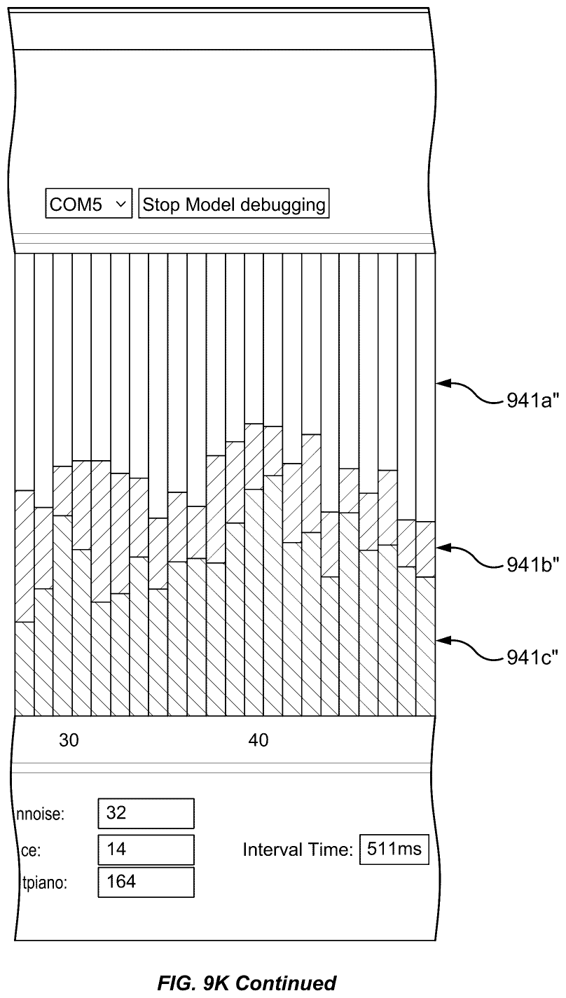

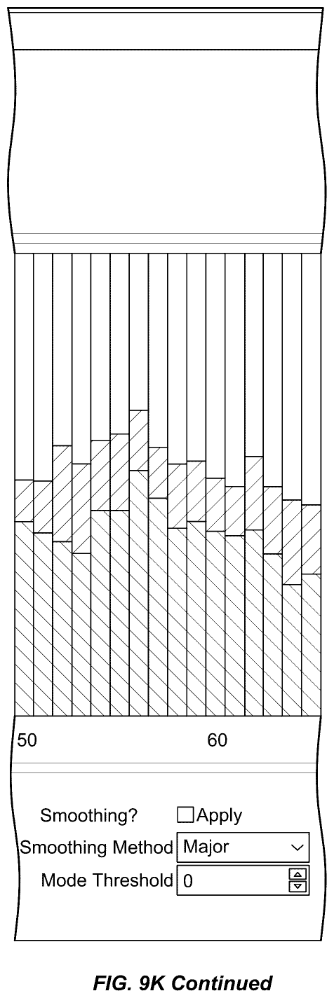

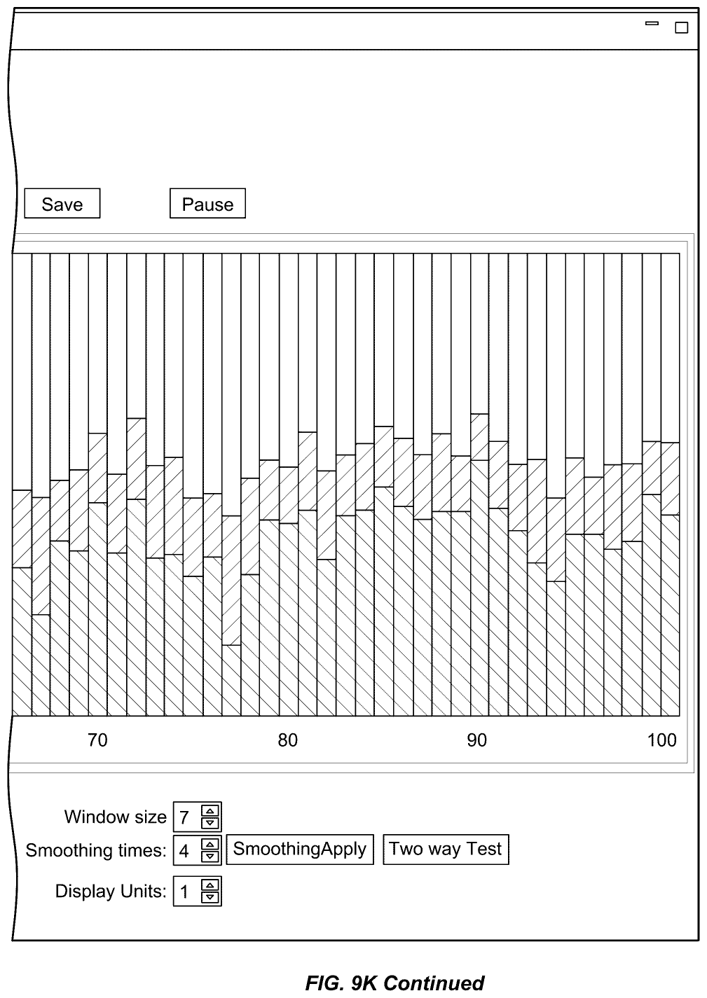

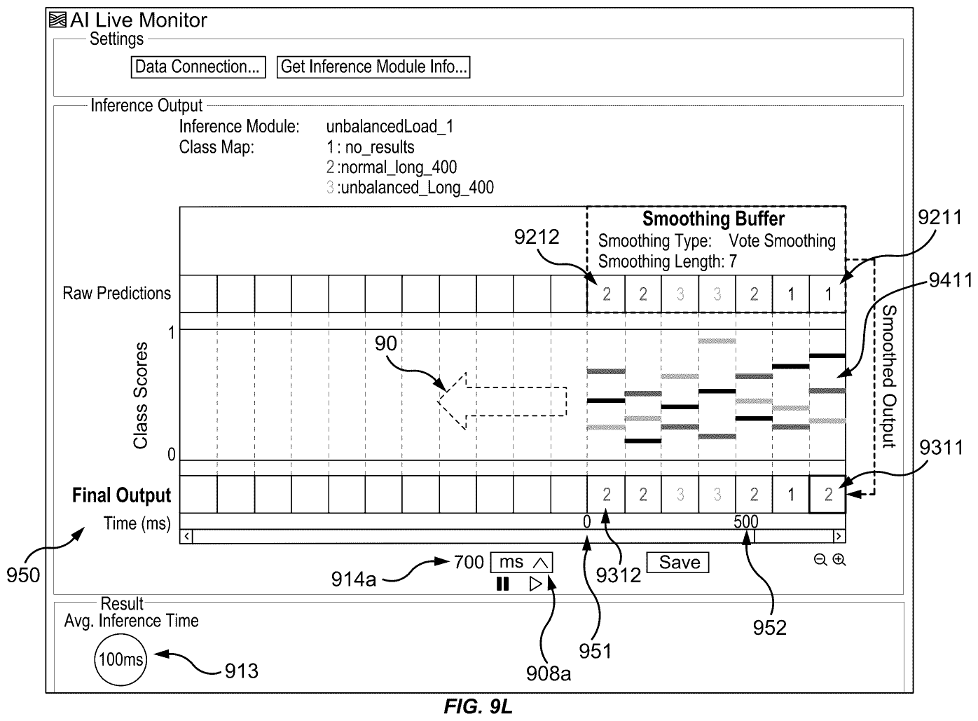

A monitoring application module 11 operating on the host system 10 may then receive the data, which may be buffered by a monitoring buffer module 111 so it can be reviewed or saved, and fed to a monitoring graphical user interface (GUI) 112 for display. Example implementations of the monitoring GUI 112 will be described further herein with reference to FIGS. 9A-9L.

Although not depicted, the monitor 11 may also include a testing module. In embodiments of the system where the determination payloads 251 provided by the DS 25 include the raw data segments 221, the testing module may run a separate analysis of each data segment to generate a separate determination value, which may be termed a verification value. The testing module may then compare that verification value to the determination value generated by the analysis module 23 for the same data frame. The result of this testing may be used to identify and diagnose errors in the determinations of the analysis module 23, and potentially to refine the analysis module 23 or its operational parameters and thereby improve accuracy.

The host system 10 will typically have other applications 13, which may include the IDE for programming the core application 28, as discussed earlier. The host system 10 may also store configuration data 12 for the analysis module 23 being monitored. In addition, the host system 10 may have an additional communications stack 16b by which it can communicate with other external systems 40 over the Internet or other network. In other embodiments, a single communications stack (e.g., communication stack 16a) may be used to communicate with both the MC 20 and other external systems 40.

For AI/ML inferences in particular, smaller modules such as those required for embedded MC systems are often highly dependent on the fine details of the received data. In this context, even minor differences in the data channel through which the data is obtained can alter the data enough to create significant deviations in the results. For this reason, data collected by host system 10 to initially train an AI/ML-based inference module 23 may be different from the data that will be collected by the MC 20 itself during practical operations of the same module 23, reducing the accuracy of inferences and determinations. However, the illustrated system addresses this issue.

Briefly, FIG. 3B is a block diagram illustrating an abstracted relationship between functional code modules on the MC 20 and the host system 10 in the context of data collection prior to training an analysis module, according to an embodiment of the disclosure. The majority of the illustrated components are the same as in FIG. 3A and their descriptions need not be repeated.

In the context of collecting data for training, a data collection and storage module (DST) 14 operating on the host system 10 may receive data from the MC 20 through the communications stack 16a, packaged into data collection payloads 252 by the DS 25. The DST 14 may buffer the data using a monitoring buffer module 141, allowing it to be reviewed or stored in a short-term data storage (not depicted), such as a random access memory or similar. Long-term local storage of the collected data may be to a data storage or memory 15; this may be the same storage containing the configuration data 12, or another storage.

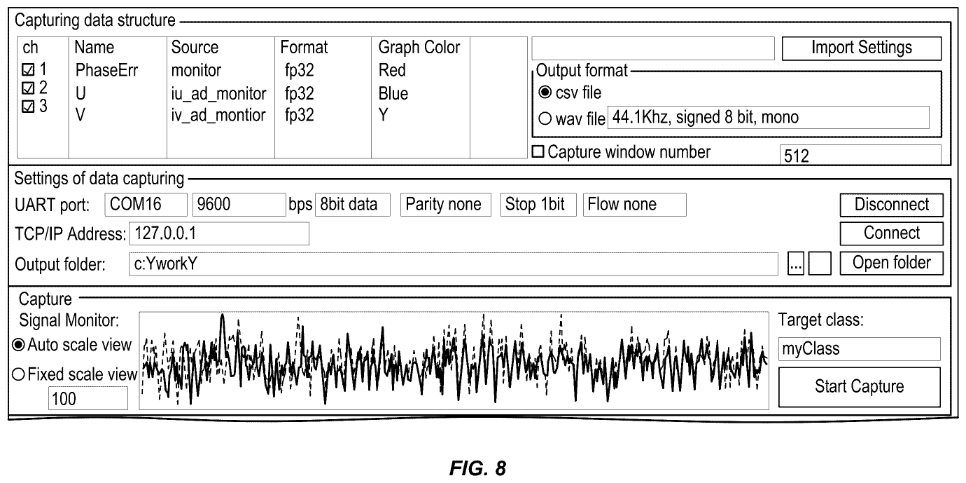

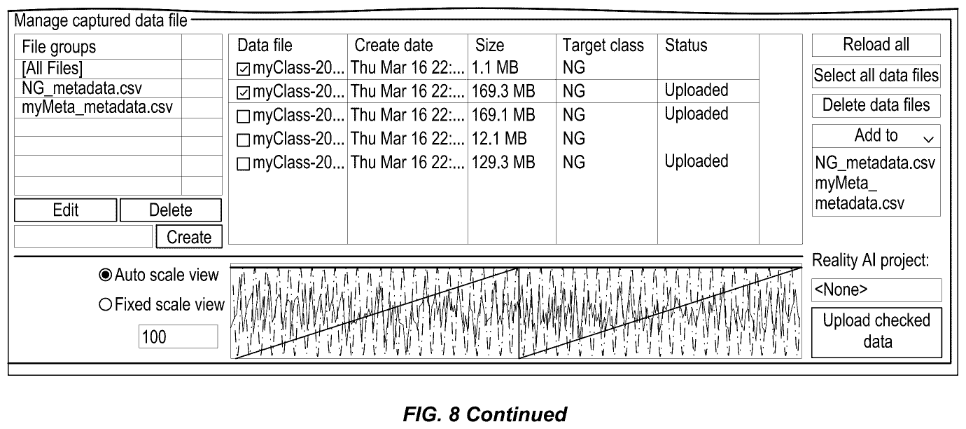

The DST 14 may also feed the data to a collection graphical user interface (GUI) 142 for display, review, and manipulation such as labeling. Briefly, one example implementation of a collection GUI 142 is presented in FIG. 8. As the details of this GUI are not central to the disclosure, they will not be elaborated upon.

The DST 14 may also upload the data to one or more external systems 40, such as an AI/ML training and testing development tool configured to train an AI/ML analysis module for later embedding in the MC 20. Module training may alternatively occur on the host system 10 itself.

The DST 14 in FIG. 3B and the monitor 11 in FIG. 3A may operate concurrently if desired, enabling the capture and analysis of raw data frames together with the output of the analysis module 23. More specifically, in embodiments of the system where the data determination payloads 251 provided by the DS 25 include the raw data frames 221, these payloads 251 may also serve as data collection payloads 252, and the DST 14 may process them in the same manner as described above.

It can be seen by comparing FIG. 3B to FIG. 3A that the raw data frames are captured by the same sources 21a and 21b, then routed through the same MC 20, using the same data channels, same hardware, and same segmentation module (namely, the DC 22), as are used by the analysis module 23, while avoiding unnecessary interaction with the application logic 24. That is, the illustrated system of FIGS. 3A and 3B standardizes the data flow across contexts. By using the same data flow for data collection as for the analysis itself, the possibility of accuracy degradation due to differences in data channels is greatly reduced, and training and testing of the analysis module 23 is improved.

The data collected through the data flow illustrated in FIG. 3B can also be used for various forms of analysis of the behavior of the MC. For example, the collected data can be used to test outcomes of the analysis module before it is even embedded, using the expected form of data. Also, if the analysis module is not behaving as expected, reviewing the collected data itself in detail can be useful; an analyst may determine that unexpectedly high noise levels, a faulty sensor, or some other influence on the data is the culprit.

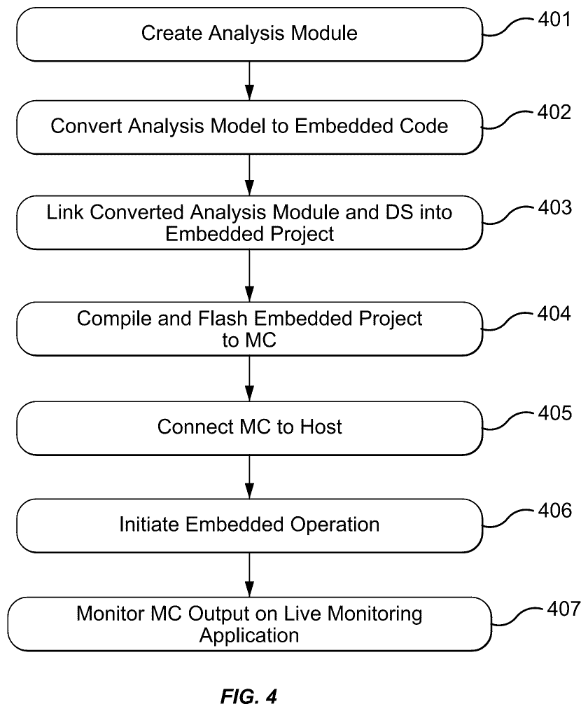

FIG. 4 is a flow diagram illustrating an example flow of processes for configuring an embedded analysis module to be monitored, according to an embodiment of the disclosure.

At 401, an analysis module is prepared. In embodiments where the analysis module is an AI/ML inference module, it is prepared through an interactive training and testing process, iteratively repeated until the accuracy of its determinations on new data is satisfactory, as described with reference to operations 1101-1103 of the method illustrated in FIG. 11. In other embodiments, alternative forms of analysis modules may be prepared during this operation by processes suitable to the respective module.

At 402, the prepared analysis module is converted to embedded code and associated parameter data, typically in C or C++, which enables the efficient realization of the module's operations on a microprocessor or microcontroller.

At 403, the executable analysis module, either in source or object form, is linked into an embedded project. This embedded project (also termed an “embedded application”) is the overall code base by which the MC software will achieve the goals of its design. As previously noted, the analysis module is typically only part of the overall function of the MC; it takes data as input and produces a determination as output, and the remainder of the embedded software acts on that output as necessary as part of its execution.

If not already included in the embedded project, a data shipper module (DS) (e.g., DS 25), is also linked into the project at 403. The DS is configured to provide data from an electronic device (e.g., the device containing MC 20) to an external monitoring workstation or similar device (e.g., host 10). The impact of this addition to the embedded project is minimal. This combined embedded project may be final production code or a development test stage, at the user's discretion.

Once the embedded project is fully configured, it is compiled using an appropriate tool chain and flashed onto an MC at 404. The MC is now fully programmed.

At 405, the MC may be connected to a host system through a communication channel (e.g., the communication stack 26 and data channel 30 as illustrated in FIG. 3A).

At 406, embedded operation of the project is initiated, typically by powering up the MC, which automatically boots and executes its firmware. At this stage, the embedded project is operating normally. During operation, the analysis module periodically analyzes received data according to its programming, and the DS packages and transmits operational data corresponding to these analyses over the communication channel. This operational data is received and monitored by a monitoring application on the host system, at 407, enabling a user to monitor previously invisible aspects of the embedded application's operation.

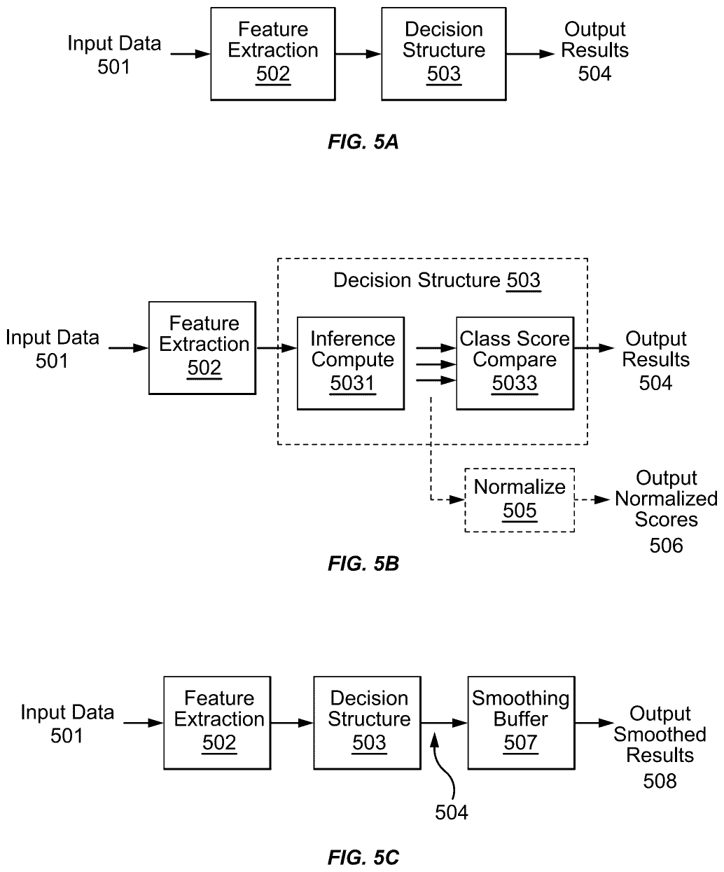

For context, this disclosure will briefly discuss the nature of this operational data, with reference to FIGS. 5A-5C.

FIG. 5A illustrates a basic AI/ML inference process in a classifier-type analysis module, according to an embodiment of the disclosure.

A data set contains one or more data points collected from data sources. When the data points of the set have been collected over the same time period (and are therefore likely to reflect the same object or event), the set is also termed a data frame.

The data set is provided as input to the module at 501, and features are extracted at 502. The feature extraction may use an explicit and closed form, such as a statistical computation or an FFT, or may be a learned operation, such as found in convolutional neural networks (CNNs). Each of these extraction processes are known in the art.

The extracted features are fed to a decision structure, such as an SVM, NN, random forest, or other suitable structure known in the art. The structure applies learned mathematical transforms at 503 to determine the most likely class of the input data frame, and outputs this result at 504.

FIG. 5B illustrates operation 503 of FIG. 5A in more detail. In a typical AL/ML inference classifier, operation 503 can be divided into two parts: determining a score for each class through inference processes, at 5031, and selecting a “winner” by examining and comparing these scores, at 5033. Scores may undergo additional processing, such as weighting before comparison, depending on the embodiment.

Optionally, the individual class scores may be normalized at 505, generating a second output at 506 that provides a ranked comparison. The normalized range may be from 0 to 1 (or, equivalently, from 0% to 100%).

Normalized scores may differ from the underlying raw individual scores of the classifier, as not all AI/ML decision architectures will naturally create scores in the normalized range. For example, while many NNs output in a range between 0 and 1 due to their activation functions, others may use the range −1 to +1. Also, many forms of SVMs will output scores in a range from 0 to −infinity. However, suitable algorithms to normalize scores are well understood in the art.

Although the disclosed system and method are not limited thereto, a preferred normalization algorithm is the SoftMax formula. SoftMax has the additional benefit of normalizing scores so that, when summed, they produce a total of 1. SoftMax-normalized scores can therefore be interpreted as an estimate of confidence, or as a probability value assigned to each class.

Preferably, the classification result output at 504 and the normalized score output at 506 are both included in the payloads sent by the data shipper module. A normalized scale provides convenient score comparison, as relative scores are more important than absolute values in determining a winner. Therefore, having both outputs enables important diagnostics for live debugging and testing, as will be further discussed.

FIG. 5C expands on the process illustrated in FIG. 5A by adding a smoothing operation 508. The output at 504 is fed to a smoothing buffer, which “smooths” the most recent N samples at 507 and outputs a smoothed result at 508. Smoothing reduces the likelihood of momentary output errors by considering recent history, thereby suppressing intermittent errors and improving overall accuracy. More specifically, smoothing examines a window of recent history and applies a function to a set of past predictions to enhance the accuracy of the current prediction. Unlike many other aspects of an AI/ML inference module, smoothing parameters, such as buffer length and smoothing type, may be easily reconfigured even after embedding the module to further refine the accuracy of its inferences. These parameters will be discussed further herein.

Although the above operations are described for an AI/ML classifier, it will be clearly understood by those of ordinary skill in the art that operation for a detector or regression output will be similar. A detector in essence outputs two classes, true or false, for the presence of a learned target, and optionally a score. A regression predicts a numerical value, which can be treated, in essence, the same as an un-normalized score value for processing purposes, without the necessity to resolve a class.

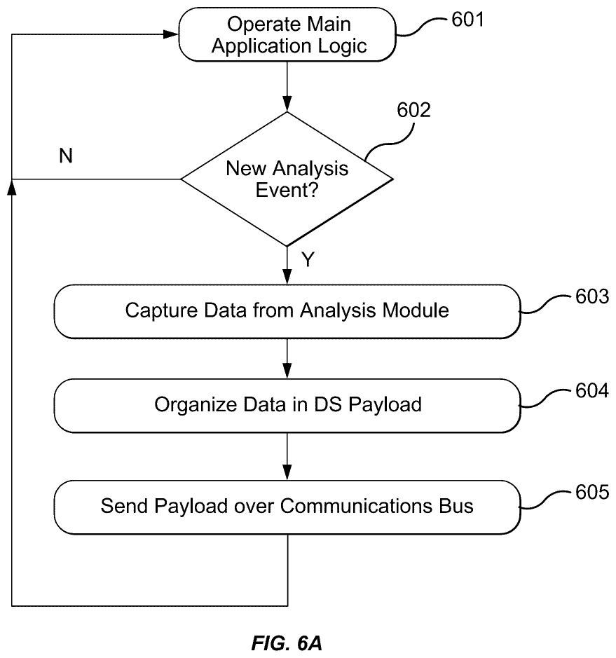

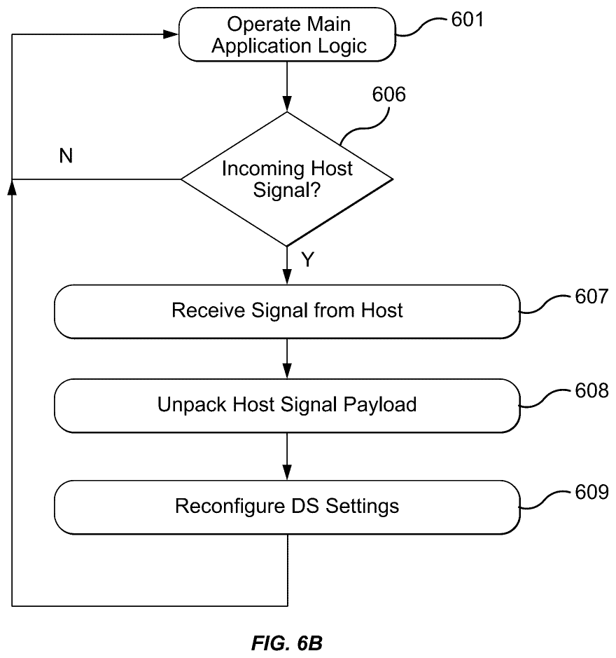

FIG. 6A is a flow diagram illustrating an example flow of processes for an embedded application to provide analysis data, according to an embodiment of the disclosure.

The embedded application continuously operates its main application logic at 601. The logic may operate the device's functions, provide user interactions, and so forth. However, in embodiments or configurations where a user is primarily interested in the analysis operation itself, the logic may be a simple loop. Regardless, operations 601 will continue until the device is halted or shut down.

At 602, it is checked whether an analysis event has occurred. It will be understood by those skilled in the art that such a branch-on-event might occur on an “if-then” statement, on an interrupt, on a callback function, or any other suitable equivalent measures known in the computer arts.

If an analysis event has occurred, the output (e.g., class or regression value) is captured, along with score data if appropriate, at 603. Optionally, the data may include both raw (pre-smoothing) and final (smoothed) outputs, as previously described. In various embodiments and configurations, the captured data might instead include only a subset of one or more of these elements.

At 604, the captured data is organized into a payload by the DS, and at 605, the payload is sent as a packet or packets over the communications bus to the host system.

The embedded system has now concluded its part in the process and returns to operation 601, and any resources are returned to the main application logic until the next analysis event. Thus, live data is captured and transmitted to the host system with little or no interference in the internal operation of the embedded application.

In certain embodiments, the execution and data sharing processes and parameters for the embedded application may be fixed at compile time, by setting constant values, flags, or particular code. In other embodiments, the configuration of the embedded application may be adjustable from outside and changed during live operation.

FIG. 6B is a flow diagram illustrating an example flow of processes for an embedded application to reconfigure operations, according to an embodiment of the disclosure.

As in FIG. 6A, the embedded application continuously operates its main application logic at 601. However, the application checks for incoming signals from the host at 606. If a signal has arrived, it is received at 607 and unpacked at 608. Commands, parameters, and settings in the signal are then applied to reconfigure the behavior of the DS, at 609.

One of ordinary skill will recognize that the processes of both FIGS. 6A and 6B may run concurrently in the same system.

Possible reconfigurations include specifying which data elements will be included in future payloads (e.g., final output but not scores). Another possible reconfiguration includes simply turning on or off transmissions, thus saving communications overhead cycles when the information is not needed.

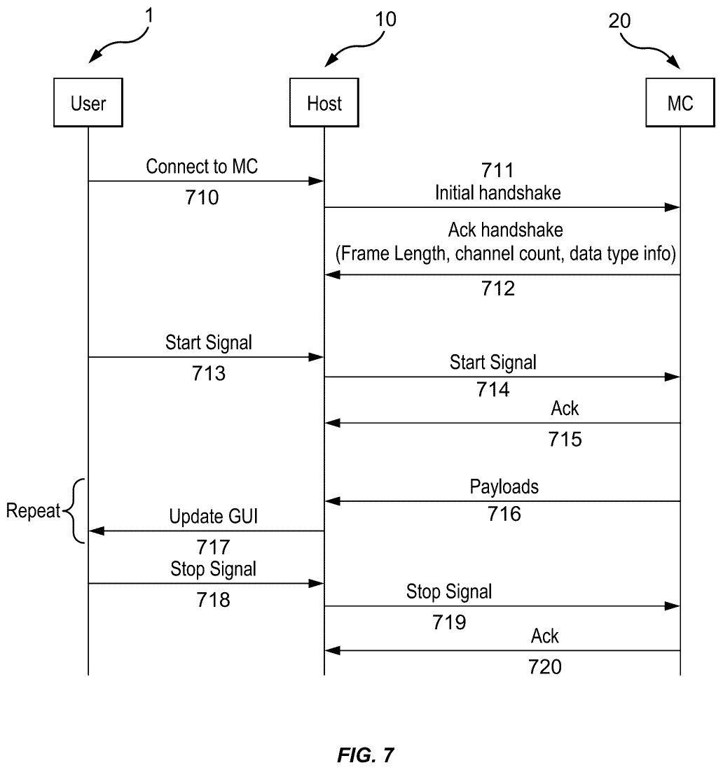

FIG. 7 is a sequence diagram illustrating an example operation flow for controlling the operations of an embedded payload module (e.g., a data shipper module) from a host system, according to an embodiment of the disclosure. The illustrated flow assumes the code has already been flashed to the MC and is running. In practice, operations and interactions on the MC 20 may be handled by the data shipper module (e.g., DS 25 in FIG. 3A), while those on the host system 10 may be handled by the monitoring application (e.g., monitor 11 in FIG. 3A).

To initiate operation, a user 1 instructs their host system 10 to connect to the MC 20, at 710. The host 10 then initiates a handshake with the MC 20, at 711. If the MC 20 is running, it acknowledges the handshake and provides the host 10 with configuration information regarding the format of data payloads to be sent, at 712. As discussed in relation to FIG. 3A, these payloads may include analysis module output 231, internal data 232, and, in some instances, the raw data 221 from the data collector buffer (DC) 22. The configuration information may set parameters for the format of this information as it will be included in the payloads, including, for example, frame length, the channels providing data, data types, and other features. The monitor 11 on the host 10 configures itself in expectation of such data.

The user instructs the host 10 to send a start signal at 713, typically through the actuation of a “go” or “play” style button on a GUI, as will be discussed further below. The monitor 11 may include a control module (not depicted) configured to format and generate this and other monitoring control signals. Responsive to this instruction, the host 10 transmits the start signal to the MC 20 at 714, and the MC 20 acknowledges at 715.

At 716, the DS 25 begins transmitting payloads corresponding to each determination from the analysis module 23 on the MC 20. At 717, information from these packets is buffered or stored on the host 10, and an interface display (e.g., GUI 112) is updated responsively. Operations 716 and 717 repeat until the user instructs the host 10 to send a stop signal at 718, typically through the actuation of a “stop” or “pause” style button on a GUI, as will be discussed further below. Responsive to this instruction, the host 10 transmits the stop signal to the MC 20 at 719, and the MC 20 acknowledges at 720.

The monitoring control signals discussed with reference to FIG. 7 are directed to controlling communication traffic from the DS 25. While these signals may, in certain embodiments, stop and start some or all of the operation of the core application 28, they preferably do not. An advantage of this configuration is that the MC 20 may continue ordinary operation regardless of whether the monitor 11 of the host 10 is operating and connected. An engineer may therefore use the product normally, placing it in various test situations, and only initiating data transmission when needed to evaluate the operation of the analysis module 23 more closely.

FIG. 7 illustrates a fully controlled interaction between the host 10 and MC 20, as also illustrated in FIG. 6B. As an alternative, the DS 25 may be configured to send data packets continually upon startup, removing the requirement that the MC 20 receive communications from the host 10. The host 10 may merely listen to the incoming packets and parse the information within, and it may ignore the packets when evaluation is not desired. In such implementations, configuration data may be carried in the packet stream or available locally on the host 10. User controls may affect information presented through the GUI, but not the actual ongoing communications from the MC 20.

Several example embodiments of portions of the GUI 112 will now be illustrated, in FIGS. 9A-9L.

The example GUI illustrated in FIG. 9A reflects the output of a classifier-type analysis module. In FIG. 9A, in the top section of the GUI, a data connection button 901 is provided to access parameters of the communications setup with the MC and the circuit on which it is installed, and a module information button 902 is provided to load information about the analysis module being monitored. In some embodiments, the information retrieved by button 902 may be provided by the IDE that merged the analysis module into the embedded firmware. In other embodiments, the information may be provided as part of the packet stream from the MC.

The retrieved information may include its name and its class map, presented at 911 and 912, respectively. The class map 912 is salient in the case of a classifier. In the illustrated example, there are three possible class outputs: “no results”, “normal”, and “unbalanced”. One of these classes will be output by the analysis module for each inference. Each class may be numerically labeled. Furthermore, each class may be color-coded, or otherwise distinguished by differences in visual characteristics, for easy reference in the main display below. The class map 912 may serve as a legend for these labels.

The example GUI presents a data plot divided into three sections: a raw output row 920, a final output row 930, and a class score chart 940. The data plot is also divided into columns, with each column representing one inference or determination instance. Each column crosses all three sections.

As illustrated, the system has already begun collecting data, which has filled the data plot. During operation, the data plot may be filled from right to left, in the manner of a horizontal scrolling chart record, such that the most recent determinations are placed in the rightmost column (e.g., the raw prediction at 921 and the final output at 9411), and the oldest visible determinations are in the leftmost column.

In the illustrated embodiment, the visible information in each column breaks down as follows:

Raw predictions 921 of the classifier appear in the top row 920. Each raw prediction 921 is determined by a decision process in the classifier, typically involving assigning a score to each possible class and selecting the highest score as the correct class, as previously discussed.

The class score chart 940 includes a series of line indicators 941, representing the relative class scores of each of the three possible classes. The line indicators 941 for each class have a distinct color or other visual characteristic, allowing a user to distinguish between classes easily.

The example GUI vertically positions each line indicator 941 on the chart 940 according to the represented score value. A winning raw prediction presented in row 920, in most classifiers, should reflect the highest score on the chart 940 in the same column. This unique presentation allows an engineer to judge how “confident” the AI/ML inference is, by reviewing the comparative scores and how close they are vertically on the chart 940. In some cases, if the classifier makes a mistake, the engineer may see that the correct answer was nevertheless a close contender. The degree of error, as judged by this, will influence the engineer's corrective action in tuning or improving the system.

In the example GUI, the presented score values have been normalized on a scale from 0 to 1, as discussed above with reference to FIG. 5B. Since the example GUI is intended to provide engineers with quick and easy visual comparison, preferred embodiments will include such intuitive normalization, although other displays are within the scope of the disclosure.

The bottom row 930 displays the final output 931 of the classifier as sent to the application logic (e.g., output 231). This output 931 may differ from the raw predictions 921 due to smoothing, as discussed above with reference to FIG. 5C, or other post-analysis weighting and adjustments.

A smoothing buffer 923 encompasses the most recent determinations in the raw prediction row 920, and is visually connected to an output link box 933 in the final output row 930, indicating that the determinations in the smoothing buffer 923 are influencing the current final output 9311 in the output link box 933 due to smoothing.

Turning briefly to FIG. 9C, the illustrated portion of the GUI includes a smoothing type indicator 9231, a smoothing window length indicator 9233, a buffer box 9235, and an output link box 933.

In the illustrated instance, the indicated smoothing type (that is, the algorithm used for smoothing), indicated by indicator 9231, is “Class Score”: the class scores for all determinations in the smoothing buffer 923 are summed (or equivalently averaged) to select a final determination for display in the final output row 930. The number of determinations considered in the smoothing buffer 923 is the buffer length: seven in the illustrated instance, as indicated by indicator 9233.

Other smoothing algorithms include, for example, “Vote Smoothing” or “Mode Smoothing,” in which the winner is selected by most common occurrence in the recent buffer, and “Arithmetic Smoothing,” in which a mean or median is selected. Arithmetic Smoothing is most applicable when dealing with numerical outputs from a regression analysis, instead of discrete classes as established by a classifier. Neither alternative algorithm is illustrated, but suitable implementations for each should be clear from context for those of skill in the art.

The smoothing type indicator 9231 also indicates the form of the buffer, which in FIG. 9C is a window. In this form, a smoothing buffer window of a fixed length (that is, a fixed number of data points, indicated at 603) “slides” over the most recent raw predictions. As each new payload is received by the monitoring application, a new raw value is added to the smoothing buffer, while the oldest value is removed from consideration.

FIG. 9D illustrates another form of the buffer: “grouped smoothing”; in such a configuration, the smoothing window length indicator 9233 indicates that the length is “Variable.” In grouped smoothing, data accumulates in the buffer until the application determines it to be complete according to predetermined criteria. Grouped smoothing is typically employed when an ongoing process dictates when a new decision window begins and ends. For example, a user might collect repeated measurements of a sound bouncing from a concrete column for a variable period of time, and the AI/ML makes a final judgment as to the quality of the column when the measurements are complete. In this example, smoothing would occur over all AI/ML inference events until the user is ready. Similarly, in an end-of-line inspection application, data might be collected on a manufactured product under the control of the assembly line, with a final judgment rendered on the product when it is removed. In other cases, external events may trigger the end of the group.

A smoothing buffer box 9235, indicated by a dotted frame, visually indicates the data contained in the smoothing buffer 923. FIGS. 9E-9G compare various instances of the smoothing buffer box 9235. In FIG. 9E, the buffer length is 7, as indicated by indicator 9233, and so the buffer box 9235 contains seven analysis results. In FIG. 9F, the buffer length is reduced to 3, and the buffer box 9235 is correspondingly shorter. In FIG. 9G, the buffer length is reduced to 1, which is equivalent to no smoothing at all.

As previously noted, smoothing parameters may be adjusted and refined on the MC with relative ease. In some embodiments, the GUI enables a user to adjust these parameters. The GUI may separately apply the adjustment to the received data on the host 10 during review, while the monitored analysis module continues to draw its own inferences based on the earlier parameters, or the GUI may send instructions to the microcontroller to adjust its internal parameters and thereby refine the operations of the monitored analysis module. The user may decide to adjust separately and experiment with the parameters until an optimal parameter set is found, then forward that parameter set to the microcontroller.

Returning to FIG. 9A, as previously noted, the most recent data is stored in the rightmost column of the data plot, at 9211 and 9311, and the data points to the left of that column are sequentially older. The GUI may provide a zoom control 903a which enables the user to adjust the number of visible columns. Typically, though not necessarily, manipulating the zoom control 903a will add or remove columns on the left side of the data plot, while fixing the rightmost column as an anchor. The zoom control 903a adds or subtracts from visible history, but preferably does not delete undisplayed information older than the displayed range from the application buffer (e.g., buffer 111 of FIG. 3A).

The GUI may provide start and pause controls 903b. A user initially uses the start control to start the viewing, which initiates the processing of new data and its display in the GUI. The start control may trigger a start signal to the MC (e.g., start signal 713 in FIG. 7) in certain embodiments, while in other embodiments it may merely instruct the monitoring application to begin processing data which was already being transmitted. Similarly, the stop/pause control instruct the monitoring application to stop processing and displaying data, and in certain embodiments may trigger a stop signal to the MC (e.g., stop signal 718 in FIG. 7). When updates are stopped, the GUI display is paused, and a user may zoom in/out and scroll to review the columns of collected data. In some embodiments, the user may save a record of the received data to a log file.

The GUI may provide a scroll bar control 904 which enables a user to scroll back and forth, moving data that has “fallen off” the leftmost column back into view on the display. The data in the rightmost column is temporarily removed to provide presentation space. Preferably, the scroll bar control 904 is only operable when the data view is paused, to avoid potential confusion from new data arriving “outside” the visible window.

The GUI may provide an inference time value indicator 913. In certain embodiments, inference time may be measured using a dedicated timer on the MC, starting the timer before each new inference and ending the timer after. This is the most accurate approach. However, in other embodiments, inference time may be measured using the host system to time the arrival of new inference data, thus approximating the inference time by the interval between outputs.

As noted, the GUI illustrated in FIG. 9A is configured to present class determination output from a classifier-type analysis module. The example GUI illustrated in FIG. 9B is similarly designed, but reflects outputs from a regression-type analysis module. The major feature changes are as follows: The raw predictions 921 are now numerical values, rather than integer classes, as are the smoothed final output values 931. The format of the data (e.g., the number of decimal places) can be set using a value format control 905. The smoothing type indicator 9231 for the smoothing buffer 923 is “Mean Score” in the illustrated instance, meaning that the most recent final output 9311 reflects a running mean for the contents of the smoothing buffer 923. Finally, the class scores chart 940 is replaced with a line chart 940′, presenting a raw prediction line 943a and a smoothed prediction line 943b for easy comparison. In a regression analysis, a comparison of these lines enables review of how well smoothing, and/or other adjustments from the raw predictions, improve and stabilize the final output.

The example GUI illustrated in FIG. 9H is a variation of the GUI illustrated in FIG. 9A. This GUI provides a project selection control 906, which enables selection of a project with which an analysis module is associated, and an analysis module selection control 907, which enables selection of an analysis module from among multiple modules that may be simultaneously included in the selected project. The zoom control and the start and pause controls are grouped together as a general chart control 903. The GUI also provides a time axis 950 to track elapsed time in the chart, along with axis controls 908 to adjust the scale of the axis and the style of the chart. A set of prediction time indicators 914, describing total time, last interval, and average interval, are also provided.

The example GUI illustrated in FIG. 9I is a variation of the GUIs illustrated in FIG. 9A and FIG. 9H, configured for a classifier without smoothing enabled. The raw prediction row 920, smoothing buffer 923, and output link box 933 are omitted as they are only salient to smoothing, simplifying the display. Although not illustrated, similar adjustments to the example GUI illustrated in FIG. 9B can be implemented for instances where smoothing is not part of a regression analysis.

The example GUI illustrated in FIG. 9J is a variation of the GUIs illustrated in FIGS. 9A and 9H. Although using a different layout and style, this GUI provides the same features and functions, and their description will not be repeated.

The example GUI illustrated in FIG. 9K is a variation of the GUIs illustrated in FIGS. 9A and 9H, implementing an alternative class score chart 940″ in which stacked bar indicators are displayed, rather than the line indicators 941 displayed in the class scores chart 940. Bands 941a″, 941b″, and 941c″ each represent a different class. Each band has a distinct color or other visual characteristic, allowing a user to distinguish between them easily. The relative proportion of the column represents the relative score of the class, with larger regions representing higher class scores. The total is always 100%.

In certain embodiments, a user may select between multiple GUIs using a chart style selection control, such as control 908 provided in the example GUI of FIG. 9H.

FIG. 9L illustrates the example GUI first illustrated in FIG. 9A, presenting additional aspects of the GUI programmatic functionality.

As noted earlier, when the GUI is first initialized, the raw predictions row 920, the final output row 930, and the class score chart 940 will not be filled. Rather, upon initialization, the GUI will begin to populate each section with values as they arrive from the MC. Each new value fills the right-most column (at, e.g., 9211, 9311, and 9411). The data scrolls to the left in the direction of arrow 90 each time a new data payload is received. Thus, the data plot will scroll like a chart recording as new data is added. The first received raw prediction 9212 and the first received final output 9312 are found in the leftmost populated column, but they are not yet in the leftmost column of the entire data plot.

The time axis 950 is adjustable according to the time scale control 908a. As illustrated, “ms” (milliseconds) are selected, and the axis 950 is correspondingly marked in ms time units. The first mark 951 on the axis 950 indicates “0 ms”, corresponding to the start of the first raw prediction 9212 and the first final output 9312. The mark spacing of the axis 950 may preferably be automatically adjusted to prevent clutter. As illustrated, the second provided mark 952 indicates “500” (that is, 500 ms). The average inference time of 100 ms, as indicated by indicator 913, corresponds to the spacing between inference values in the chart, and therefore, the second provided mark 952 corresponds to the fifth received value. The total time indicator 914a presents the time elapsed since initialization, which as illustrated is 700 ms.

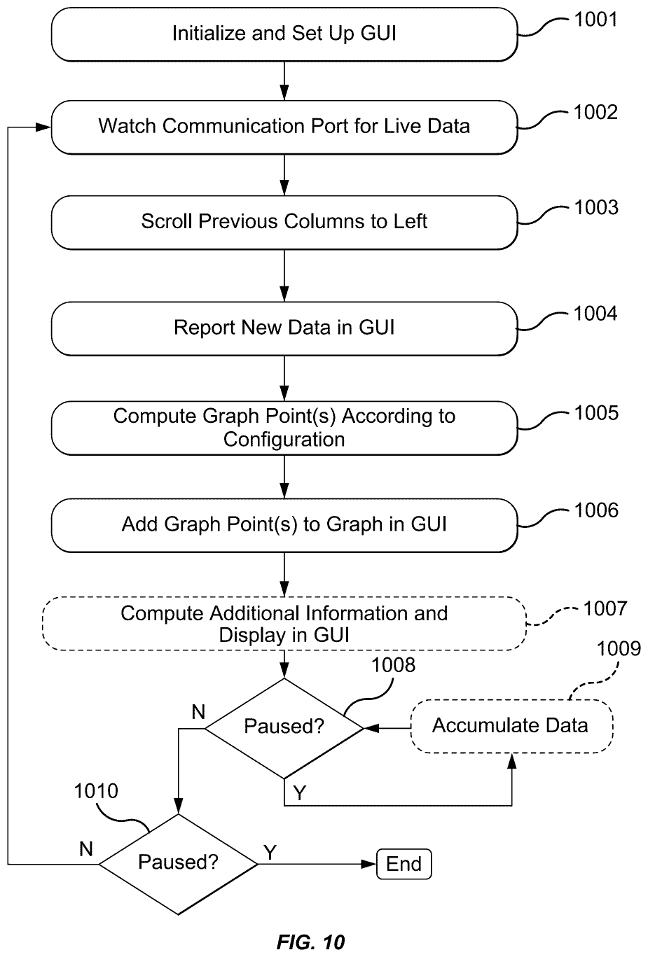

FIG. 10 is a flow diagram illustrating an example flow of processes for receiving and presenting analysis data in a monitoring application, according to an embodiment of the disclosure. The descriptions below assume use of the example GUIs illustrated in FIGS. 9A-9L, or similar, but those of ordinary skill will be able to extrapolate to other GUI designs.

Upon start up, at 1001, the application configures itself and initializes the GUI. The initialized GUI may provide data for various fields if retrievable, or if a default value is provided and applicable; if not, a placeholder or a blank area may be displayed.

In certain embodiments, where smoothing can change during live operations (not depicted in FIG. 10), smoothing parameter indicators (e.g., indicators 9231 and 9233 in FIG. 9C) may be updated periodically in the GUI based on payloads or other signals through communications channels, rather than fixed at the time of initialization.

After configuring and initializing the GUI, the system then waits to receive live data from the embedded side, by watching the incoming communications port on the host system, at 1002.

Once valid data is received for a new analysis event, the following operations are repeated:

Any previous data in the columnar areas (e.g., the raw predictions, class indicators, and final output) are scrolled one column to the left at 1003, leaving the rightmost column momentarily blank. (In the first iteration, the columnar areas will be blank, and this operation can be omitted.) If all visible columns are full, the oldest (leftmost) column is scrolled off screen and is no longer visible, though preferably its contents remain stored in memory.

At 1004, new prediction data is added to the GUI. An example execution of this operation has already been depicted in FIG. 9L, although, again, any suitable GUI is within the scope of the present system. In the context of FIG. 9L, new predictions in both the final output row 930 and raw prediction row 920 (assuming the option to present both is selected) are reported at positions 9211 and 9311, respectively, in the rightmost column, which was cleared at 1003 as the existing data was moved to the left.

At 1005, graph points are computed according to the scores received, normalized for the display range of the GUI. At 1006, the graph points are added to the graph area, depicted, for example, as line indicators. In the context of FIGS. 9A-9L, the graph points are added to the class score chart 940, in the rightmost column.

The value and display format of the graphs will depend upon the settings. For a classifier, in certain embodiments, the graph may include line indicators indicating individual class scores, which may be colored or otherwise visually distinguished, for example as illustrated in FIG. 9A. For a regression determination, in certain embodiments, the display may include a line chart with lines respectively indicating the raw and smoothed scores, for example as illustrated in FIG. 9B. In certain embodiments, alternative graph formats, for example as illustrated in FIG. 9K, may be the default, or may be selected by a user.

Following operation 1006, the newest (rightmost) column of data displays new data for both predictions and graphical score or value information.

Certain embodiments may update additional data, at 1007. For example, an inference interval (e.g., inference time 913 in FIG. 9L, or interval times 914 in FIG. 9H) may be computed and displayed, as previously described. Smoothing data may be updated if it changes during operation. Other embodiments may add additional updated data elements.

In certain embodiments, at 1008, the host system determines if the user has placed the monitoring application in a “pause” state by operating a control (e.g., control 903b in FIG. 9A), in which display updates are paused until resumed by the user. While in a “pause” state, certain embodiments may continue to accumulate and buffer new data at 1009 without displaying it, while other embodiments may discard such data, and still others may instruct the DS on the MC to cease transmission as described with reference to FIG. 6B. During the “pause” state, the user may explore and examine previously recorded data by using a scrolling control (e.g., scroll bar 904 in FIG. 9A), and/or may adjust the visible number of columns by using a zoom control (e.g., zoom controls 903a in FIG. 9A). While inclusion is preferred, certain embodiments may omit a “pause” capability.

If the monitoring application is not paused (or once it has been resumed from pause mode), the host system determines if the process has terminated, at 1010. If not, the process loops around to 1002 and enters another iteration. Typically, as described for example with reference to FIG. 9L, the next iteration continues to accept new incoming data and fills the display from right to left. When the available number of columns are filled, the next iteration of operation 1003 scrolls the old data off the left side of the display.

The process continues until the monitoring application is terminated at 1010.

The disclosed system and method are not limited to monitoring only one analysis module, but may easily monitor more than one module, in one or many embedded devices. As but one example, the monitoring application may open separate respective GUI windows for each module. As another example, controls in the GUI, such as buttons 906 and 907 in FIG. 9H, may enable the switching of monitoring between analysis modules and devices.

Using the monitoring application, a user may review individual determinations of an embedded inference module in real time. Additionally, the same data that the inference module is analyzing may also be analyzed on a testing module, as previously discussed, to verify accuracy of those determinations. If the determinations are inaccurate, the user may take certain measures to refine the accuracy of the inference module. For example, a local copy of the inference module may be trained further on the received data, particularly on received data that the embedded inference module analyzed incorrectly; once the local inference module's refinement training is completed, it may replace the embedded inference module in the microcontroller. However, a user may determine that certain types of errors can be corrected through adjustment of the existing inference module's operating parameters, including but not limited to smoothing parameters as discussed above. This form of refinement, if effective, is far quicker and simpler to implement than a full retraining.

These and related processes, along with other necessary instructions, may be encoded as executable instructions on one or more non-transitory computer-readable media, such as hard disk drives or optical discs, and executed using one or more computer processors in conjunction with an operating system or other suitable measures. Additionally, one or more of the components described above may be implemented as instructions stored on a computer-readable storage medium and executable by at least one processor (and/or may include at least one processor).

These computer-readable program instructions may be provided to a processor of a general purpose computer, special purpose computer, or other programmable data processing apparatus to produce a machine. The instructions, which execute via the processor of the computer or of another programmable data processing apparatus, thereby create means for implementing the functions/acts specified in the flowchart and/or block diagram block or blocks. The computer-readable program instructions may also be stored in a computer-readable storage medium that can direct a computer, a programmable data processing apparatus, and/or other devices to function in a particular manner. The resulting computer-readable storage medium then comprises an article of manufacture including instructions to implement aspects of the function/act specified in the flowchart and/or block diagram block or blocks.

The computer-readable program instructions may also be loaded onto a computer, other programmable data processing apparatus, or other device, executing a series of operational steps established in the computer-readable program instructions and producing a computer-implemented process. More specifically, the instructions may be executed on the device to implement the functions/acts specified in the flowchart and/or block diagram block or blocks.

In a software implementation, the software may include a plurality of computer-executable instructions to be implemented on a computer system. Before being loaded into a computer system, the software may exist as encoded information on a suitable tangible, non-transitory computer-readable storage medium, such as magnetic, optical, or other suitably encoded or recorded media. The computer-readable storage medium may be a tangible device that retains and stores instructions for use by an instruction execution device. The computer-readable storage medium can include, but is not limited to, an electronic storage device, a magnetic storage device, an optical storage device, an electromagnetic storage device, a semiconductor storage device, and any suitable combination of the above devices. A non-exhaustive list of more specific examples of computer-readable storage media includes: a portable computer diskette, a hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, and mechanically encoded devices such as punch cards or raised structures in a groove with instructions recorded thereon, as well as any suitable combination of the above media. In certain embodiments, the computer-readable storage medium may take the form of pre-existing data storage (such as “cloud storage”) that is accessible through operably coupled network means (such as the Internet). A computer-readable storage medium, as used herein, should not be interpreted as transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing or processing devices from a computer-readable storage medium or to an external computer or external storage device via a network, such as the Internet, a local area network, a wide area network, or a wireless network. The network may include copper transmission cables, optical transmission fibers, wireless transmission, routers, firewalls, switches, gateway computers, and/or edge servers. A network adapter card or network interface in each computing or processing device receives computer-readable program instructions from the network and forwards these instructions for storage in a computer-readable storage medium within the respective computing or processing device.

Computer-readable program code or instructions for carrying out operations may include assembler instructions, instruction set architecture (ISA) instructions, machine instructions, machine-dependent instructions, microcode, firmware instructions, state-setting data, configuration data for integrated circuitry, or either source code or object code written in any combination of one or more programming languages. Possible languages include object-oriented programming languages such as Smalltalk, C++, or similar; and procedural programming languages such as Pascal, C, or similar. The computer-readable program instructions may execute entirely on a user's computer, as a stand-alone software package, partly on the user's computer and partly on a remote computer or server, or entirely on the remote computer or server. In scenarios involving a remote computer or server, the remote device may connect to the user's computer through any type of network, including a local area network (LAN) or a wide area network (WAN), or the connection may be established though an external computer (for example, via the Internet using an Internet Service Provider). In some embodiments, electronic circuitry, such as programmable logic circuitry, field-programmable gate arrays (FPGA), or programmable logic arrays (PLA), may execute the computer-readable program instructions by utilizing the state information of these instructions to personalize the electronic circuitry and perform specific operations.

In certain implementations, a system may include a dedicated processor, processing segments of a system on chip (SoC), segments of a field-programmable gate array (FPGA), or other suitable measures, executing processor instructions to perform the functions described herein or to emulate certain structures defined herein. Suitable circuits using, for example, discrete logic gates such as in an Application Specific Integrated Circuit (ASIC), Programmable Logic Array (PLA), or Field Programmable Gate Arrays (FPGA) are also developed in certain embodiments to perform these functions.

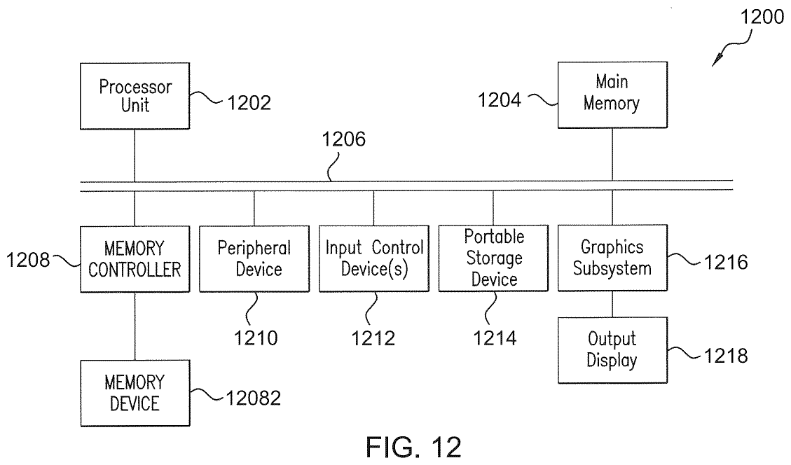

As an example, FIG. 12 is a block diagram illustrating an exemplary computer system for programmatic and/or hardware implementation of various aspects of the disclosed system and method. For instance, in various embodiments, it functions as a host for hardware modules and/or executes software modules, such as electronic design automation (EDA) tools, simulations, emulation, and firmware, according to the different configurations of the disclosed system and method.

According to certain embodiments, computer system 1200 includes a processor 1202, a main memory 1204, an interconnect bus 1206, a memory controller 1208 that is coupled to a memory device 12082, peripheral device(s) 1210, input control device(s) 1212, portable storage medium drive(s) 1214, a graphics subsystem 1216, and an output display 1218. Depending on the particular embodiment and the requirements of the intended application, all or only certain portions of the system components functionally shown may need actual implementation. In various embodiments, processor 1202 includes a single microprocessor or a plurality of microprocessors for configuring computer system 1200 as a multi-processor system. Main memory 1204 stores, in part, instructions and data to be executed by processor 1202. Main memory 1204 preferably includes banks of dynamic random access memory (DRAM) as well as high-speed cache memory.

For simplicity, the components of computer system 1200 are depicted as interconnected via interconnect bus 1206. However, in alternative embodiments, computer system 1200 is interconnected through one or more data transport methods. For example, in certain embodiments, processor 1202 and main memory 1204 are interconnected via a local microprocessor bus, while memory controller 1208, peripheral device(s) 1210, portable storage medium drive(s) 1214, and graphics subsystem 1216 are interconnected via one or more input/output (I/O) buses. Memory device 12082 is preferably implemented as nonvolatile semiconductor memory for storing data and instructions to be used by processor 1202. Additionally, memory device 12082 is preferably used to store the software needed to load it into main memory 1204; however, in alternative embodiments, it may be represented in an EDA tool simulation by suitable classes (incorporating data structures and functions operable upon the data structures) or similar methods known to those skilled in the art.

Portable storage medium drive 1214 operates to input and output data and code to and from the computer system 1200. In one configuration, the software is stored on such a portable medium, and is input to computer system 1200 via portable storage medium drive 1214. In various embodiments, peripheral device(s) 1210 may include any type of computer support device such as an input/output (I/O) interface, to add additional functionality to computer system 1200. For example, in certain embodiments, peripheral device(s) 1210 includes a network interface card, to interface computer system 1200 to a network. In certain embodiments, peripheral device(s) also includes a memory controller and nonvolatile memory.

Input control device(s) 1212 provide a portion of the user interface for a computer system 1200 user. In various embodiments, input control device(s) 1212 may include an alphanumeric keypad for inputting alphanumeric and other key information, and a cursor control device such as a mouse, a trackpad or stylus, or cursor direction keys.

To display textual and graphical information, computer system 1200 includes graphics subsystem 1214 and output display(s) 1218. In various embodiments, output display 1218 may include a cathode ray tube (CRT) display, liquid crystal display (LCD), plasma, or active matrix organic light emitting diode (AMOLED) display. Graphics subsystem 1216 receives textual and graphical information, and processes the information for output to display 1218.

Using the disclosed system and method, an engineer may visualize live activity in an otherwise closed embedded system. This can be applied not only at the evaluation board prototype stage, but also in production hardware created by the engineer. The disclosed system and method thereby facilitate a rapid transition to live testing of the complete device, as well as deep review of the actions and interior state of the analysis modules for analysis and debugging, and represent a significant advance in the art.

It will be apparent that numerous modifications and variations of the disclosed system and method are possible in light of the above teachings. Additionally, it will be apparent that the disclosed system and method may be practiced in ways other than those explicitly described herein. Furthermore, any or all of the disclosed elements and operations may be selectively combined, and particular locations of elements or sequences of operations may be reversed or interposed, all without departing from the spirit or scope of the disclosed system and method as defined in the appended claims. Therefore, the scope should be determined with reference to the present disclosure and the appended claims, along with their full range of equivalents.

What is claimed is:

1. A system for monitoring inferences performed by a microcontroller (MC) in real time, the system comprising:
an MC communicatively coupled to an electronic device, the MC comprising:
at least one MC processor,
an MC communication stack configured to transmit and receive a signal, and
an MC memory having embedded thereon MC program code executable by the at least one MC processor, the MC program code comprising:
an inference module configured to cause at least one of the at least one MC processor to analyze a data set and generate a determination value corresponding thereto, the electronic device selectively performing at least one operation based on the determination value, and
a payload module configured to cause at least one of the at least one MC processor to generate, for each determination value generated by the inference module, a determination data payload representing the determination value, and to transmit the determination data payload through the MC communication stack; and
a monitoring subsystem external to the MC and communicatively coupled to the MC, the monitoring subsystem comprising:
at least one monitoring processor,
a monitoring communication stack configured to transmit and receive a signal,
a display, and
a monitoring memory having encoded thereon monitoring program code executable by the at least one monitoring processor, the monitoring program code comprising:
a monitoring module configured to cause at least one of the at least one monitoring processor to process a plurality of determination data payloads received through the monitoring communication stack and originating from the MC communication stack, and
an interface module configured to cause at least one of the at least one monitoring processor to visually render a user interface on the display, the user interface visually representing the determination value of at least one determination data payload of the plurality of determination data payloads.

2. The system of claim 1, wherein:
the determination value is generated based on at least one intermediary value generated during analysis of the corresponding data set, and
the determination data payload further represents the at least one intermediary value on which the determination value is based.

3. The system of claim 1, wherein the determination data payload further represents the data subset corresponding to the determination value.

4. The system of claim 3, wherein:
the monitoring program code further includes a testing module configured to cause at least one of the at least one monitoring processor to, for the at least one determination data payload of the plurality of determination data payloads:
generate at least one verification value, based on an analysis of the data subset represented thereby, and
generate a testing result, based on a comparison of the generated verification value with the determination value represented thereby.

5. The system of claim 1, wherein the inference module is an artificial intelligence (AI) inference module.

6. The system of claim 5, wherein:
the payload module is further configured to cause at least one of the at least one MC processor to generate, for each data set of a plurality of data sets, a data collection payload representing the data set, and to transmit the data collection payload through the MC communication stack, and
the monitoring program code further comprises a data storage module configured to cause at least one of the at least one monitoring processor to store, in a data storage, a received data collection payload received through the monitoring communication stack.

7. The system of claim 5, wherein:
the determination data payload further represents the data subset corresponding to the determination value, and
the monitoring program code further comprises a data collection module configured to cause at least one of the at least one monitoring processor to process the data subset represented in the received determination data payload for AI training.

8. The system of claim 1, wherein:
the monitoring program code further comprises a control module configured to cause at least one of the at least one monitoring processor to generate a monitoring control signal for transmission through the monitoring communication stack,
the payload module is configured to cause at least one of the at least one MC processor to selectively transmit the determination data payload through the MC communication stack based on receipt of the monitoring control signal through the MC communication stack, and
the inference module is configured to cause at least one of the at least one MC processor to analyze a data set and generate at least one determination value corresponding thereto irrespective of receipt of the monitoring control signal through the MC communication stack.

9. The system of claim 1, wherein the MC program code further comprises a buffer module configured to cause at least one of the at least one MC processor to organize data into a plurality of data sets configured to be analyzed by the inference module.

10. A method for monitoring inferences performed by a microcontroller (MC) in real time, the method comprising:
establishing an MC comprising at least one MC processor, an MC communication stack configured to transmit and receive a signal, and an MC memory having embedded thereon an inference module;
establishing a monitoring subsystem external to the MC and communicatively coupled to the MC, the monitoring subsystem comprising at least one monitoring processor, a monitoring communication stack configured to transmit and receive a signal, a monitoring memory, and a display;
by the at least one MC processor, obtaining a plurality of data sets;
by the at least one MC processor, for each data set of the plurality of data sets:
analyzing the data set to generate at least one determination value corresponding thereto,
generating a determination data payload representing the determination value, and
transmitting, through the MC communication stack, the determination data payload;
by the at least one monitoring processor, receiving, through the monitoring communication stack, a plurality of determination data payloads originating from the MC communication stack; and
by the at least one monitoring processor, generating a user interface on the display representing the determination value of each processed determination data payload of the received plurality of determination data payloads.

11. The method of claim 10, wherein:
the analyzing of each data set of the plurality of data sets comprises:
generating at least one intermediary value based on the data set,
generating the at least one determination value based on the at least one intermediary value; and
the determination data payload further represents the at least one intermediary value on which the determination value is based.

12. The method of claim 10, wherein each generated determination data payload further represents the data subset corresponding to the determination value, the method further comprising:
by the at least one monitoring processor, for at least one determination data payload of the plurality of determination data payloads:
generating at least one verification value, based on an analysis of the data subset represented thereby, and
generating a testing result, based on a comparison of the generated verification value with the determination value represented thereby.

13. The method of claim 10, wherein:
the inference module is an artificial intelligence (AI) inference module, and
each generated determination data payload further represents the data subset corresponding to the determination value,
the method further comprising, by the at least one monitoring processor, processing the data subset represented in the received determination data payload for AI training.

14. The method of claim 10, further comprising, by the at least one monitoring processor, generating a monitoring control signal for transmission through the monitoring communication stack, wherein:
the at least one MC processor selectively transmits the determination data payload through the MC communication stack based on receipt of the monitoring control signal through the MC communication stack, and
the at least one MC processor, for each data set of the plurality of data sets, analyzes the data set to generate at least one determination value corresponding thereto irrespective of receipt of the monitoring control signal through the MC communication stack.

15. A method for training and refining an artificial intelligence (AI) module of a microcontroller (MC), the method comprising:
establishing an MC comprising at least one MC processor, an MC communication stack configured to transmit and receive a signal, and an MC memory;
establishing a trained AI module;
embedding the trained AI module to the MC memory;
establishing a testing subsystem external to the MC and communicatively coupled to the MC, the testing subsystem comprising at least one testing processor, a testing communication stack configured to transmit and receive a signal, a testing memory, and a display;
by the at least one MC processor, obtaining a plurality of testing data sets;
by the at least one MC processor, for each testing data set of the plurality of testing data sets:
analyzing the testing data set to generate at least one testing determination value corresponding thereto,
generating a testing data payload representing the testing determination value, and
transmitting, through the MC communication stack, the generated testing data payload;
by the at least one testing processor, receiving, through the testing communication stack, a plurality of testing data payloads originating from the MC communication stack; and
by the at least one testing processor, generating a user interface on the display representing the at least one testing determination value of each processed testing data payload of the received plurality of testing data payloads.

16. The method of claim 15, wherein each testing data payload further represents the testing data set corresponding to the testing determination value, the method further comprising:
by the at least one testing processor, for at least one of the plurality of testing data payloads:
analyzing the testing data set represented thereby to generate at least one testing verification value corresponding thereto, and
generating a testing result, based on a comparison of the generated verification value with the determination value represented thereby.

17. The method of claim 16, wherein the MC processor analyzes the testing data set based on a value of at least one analysis parameter, the method further comprising:
by the at least one testing processor, generating a refinement instruction responsive to the testing result;
by the at least one testing processor, transmitting, through the testing communication stack, the refinement instruction;
by the at least one MC processor, receiving, through the MC communication stack, the refinement instruction;
by the at least one MC processor, adjusting the value of the at least one analysis parameter based on the refinement instruction.

18. The method of claim 15, wherein the trained AI module is established by:
establishing a training subsystem external to the MC and communicatively coupled to the MC, the training subsystem comprising at least one training processor, a training communication stack configured to transmit and receive a signal, and a training memory;
by the at least one MC processor, obtaining a plurality of training data sets;
by the at least one MC processor, for each training data set of the plurality of training data sets:
generating a training data payload representing the training data set, and
transmitting, through the MC communication stack, the generated training data payload;
by the at least one training processor, receiving, through the training communication stack, a plurality of training data payloads originating from the MC communication stack;
by the at least one training processor, training an AI module based on the received plurality of training data payloads to generate the trained AI module.

19. The method of claim 18, wherein the testing subsystem is the training subsystem.

20. The method of claim 19, wherein each testing data payload further represents the testing data set corresponding to the testing determination value, the method further comprising:
by the at least one testing processor, for at least one of the plurality of testing data payloads, analyzing the testing data set represented thereby to generate at least one testing verification value corresponding thereto;
by the at least one training processor, retraining the AI module based on the at least one of the plurality of testing data payloads to generate a refined AI module; and
embedding the refined AI module to the MC memory.
